(19) United States
(12) Patent Application Publication
(10) Pub. No.: US 2023/0310964 A1
(43) Pub. Date: Oct. 5, 2023

(54) Spin Analysis for a Projectile in Flight

(71) Applicant: Graff Golf LLC, Sandy Springs, GA (US)

(72) Inventors: Eric Goodchild, Edmond, OK (US); Gabriel Hannon, New York, NY (US)

(73) Assignee: Graff Golf LLC, Sandy Springs, GA (US)

(21) Appl. No.: 18/108,589

(22) Filed: Feb. 11, 2023

Related U.S. Application Data
(63) Continuation-in-part of application No. 17/953,231, filed on Sep. 26, 2022.
Application No. 17/953,231 is a continuation-in-part of application No. 17/121,586, filed on Dec. 14, 2020, now Pat. No. 11,452,919.
Application No. 17/121,586 is a continuation-in-part of application No. 16/438,412, filed on Jun. 11, 2019, now Pat. No. 10,864,410.
(60) Provisional application No. 62/824,820, filed on Mar. 27, 2019.

(51) Int. Cl. A63B 69/36

(52) U.S. Cl. CPC A63B 69/3658; A63B 2220/35; A63B 2220/44; A63B 2220/833; A63B 2225/50

(57) ABSTRACT

A system and method for measuring golf ball trajectory characteristics is disclosed. A device may collect a user and ball magnetometer and accelerometer frame of reference vectors. A device may calculate frame of rotation coefficients from the user magnetometer frame of reference vector, the user accelerometer frame of reference vector, the ball magnetometer frame of reference vector, and the ball accelerometer frame of reference vector using a Kabsch Algorithm. A device may collect a ball magnetometer time series matrix from the ball magnetometer as the ball is in flight. A device may process the ball magnetometer time series through a Rodrigues Rotation Formula using the frame rotation coefficients to create a rotation vector. A device may calculate a prior vector difference and a second prior vector difference. A device may calculate the spin axes by multiplying the prior vector difference by the second prior vector difference. A device may calculate a Theta vector by taking an arccosine of a dividend of a product of the prior vector difference multiplied by the second prior vector difference divided by a product of an absolute value of the prior vector difference multiplied by an absolute value of the second prior vector difference. A device may calculate the spin rate by dividing a change in Theta by the change in time. A device may display the spin rate and the spin axes on a display device.

### RELATED APPLICATIONS

This patent application is a continuation-in-part of U.S. Pat. Application 17/953,231, “Golf Ball Analytic Measurement Device and Method”, filed on Sep. 26, 2022. U.S. Pat. Application 17/953,231 is a continuation-in-part of U.S. Pat. Application 17/121,586, “Bluetooth Enabled Ball Analyzer and Locator”, filed on Dec. 14, 2020, now U.S. Pat. 11,452,919. U.S. Pat. application 17/121,586 is a continuation-in-part of U.S. Pat. Application 16/438,412, “Bluetooth Enabled Ball Analyzer and Locator”, filed on Jun. 11, 2019, now U.S. Pat. 10,864,410. U.S. Pat. Application 16/438,412 is a non-provisional patent application claiming priority to U.S. Pat. Provisional Pat. Application 62/824,820, “A Bluetooth chip designed to track proximity and play a sound, along with an accelerometer, that is embedded inside of a golf ball”, filed on Mar. 27, 2019, by inventors Aaron Shapiro and Mike Eberle. The disclosures of the provisional and non-provisional patent applications are incorporated herein by reference in their entirety.

### TECHNICAL FIELD

The system, apparatuses, and methods described herein generally relate to projectile analytics and, in particular, to methods and devices for analyzing golf ball trajectories.

### DESCRIPTION OF THE RELATED ART

Golf as we know it today originated from a game played on the eastern coast of Scotland in the Kingdom of Fife during the 15th century. Players would hit a pebble around a natural course of sand dunes, rabbit runs, and tracks using a stick or primitive club. Wooden golf balls were the first man-made golf balls, invented in the 1400s. These original wooden golf balls were inefficient at best and likely made of hardwoods such as Beech or Boxroot. The first “real” golf ball was known as a “feathery” golf ball. Basically, the feathery was a leather sack filled with boiled goose feathers, then stitched up and painted. These golf balls were used from the 1400s until the 1840s. In 1848, Rev. Dr. Robert Adams began creating golf balls out of Gutta Percha “Gutty”. The Gutty golf ball was created from the dried sap of the Sapodilla tree. It had a rubber-like feel and was formed into ball shapes by heating it up and shaping it while hot. It was soon discovered that dinged balls traveled further than new, smooth balls, and golf ball manufacturers added dimples to the golf balls.

In the late 1800s, the inside of the golf ball changed to a solid rubber core, high tension rubber thread wrapped around the core, and a Gutta Percha cover. Various other cores were incorporated over the following years, with liquid, steel, lead, and glycerin used at various times. Today, two-piece solid Syrlin or Balata cover rubber cored balls are used. Recent rule changes (United States Golf Association (USGA)) for standard golf balls have allowed for balls with hollow steel spheres surrounded with rubber. With the improved designs in golf balls, the balls travel further. However, this means that the golf ball can travel further out of sight of the golfer and are more often lost than they were in the 1800s.

On average, most golfers lose four balls per round, adding a total of 20 minutes of play just searching for their ball. This means that tens of millions of golf balls are lost each year, leading to millions of dollars in extra cost to golfers. And the 20-minute delay searching for lost golf balls slows down play on the course, leading to lost revenues for the country clubs.

There is a need for the technology of finding golf balls to catch up to the materials technology that has allowed for longer golf ball drives. The extreme number of lost golf balls creates a significant problem for golfers both in terms of cost and the inability of golfers to analyze their round. Golf balls can easily be lost in bushes and trees. They give the golfer no easy way to track golf ball movements and statistics.

There is a need for technology inside the balls to allow them to be found quickly through proximity and sound. However, each golf ball may undergo 15,000 G’s of force when the golf club hits the ball. Off of the club, the ball may spin at 9000 RPMs and travel at 180 miles per hour, so the technology must be hardened to the extreme physical forces. There is also a need for a software application to give a golfer helpful analytical data.

### BRIEF SUMMARY OF THE INVENTION

This document describes a system for monitoring a golfer’s performance. The system is made up of two components, a golf ball, and a central interrogator.

The golf ball has embedded electronics. The golf ball comprises a processor electrically connected to golf ball communications circuitry, memory, and a spin detector electrically connected to the processor. The spin detector directs data regarding the rotation of the spin detector to the processor. The processor converts the data regarding the rotation of the spin detector into a rotation speed and a rotation direction, the rotation speed determined by a frequency of the data and said rotation direction determined by a magnitude of the data. The processor converts the data through a calculation and stores said rotation speed and said rotation direction in the memory. The golf ball mechanically encompasses the processor and the spin detector.

The central interrogator comprises a central interrogator processor, central interrogator communications circuitry electronically connected to the central interrogator processor, the central interrogator communications circuitry wirelessly connected to the golf ball communications circuitry, and a display screen electrically connected to the central interrogator processor. Application software executes on the central interrogator processor, said application software interrogates the golf ball through the central interrogator communications circuitry for the rotation speed and said rotation direction regarding the rotation of the spin detector. The application software derives analytics on the golfer’s performance from the rotation speed and the rotation direction for display on the display screen.

In some embodiments, the spin detector in the golf ball is a Magnetoresistive sensor or a gyroscope, or an accelerometer. The central interrogator could be a smartphone.

The data sent by the golf ball to the central interrogator could comprises hang time, exit velocity, launch angle, and/or carry distance. The golf ball could also include a electrically connected to the processor. The central interrogator processor could wirelessly transmits an instruction to the golf ball to activate the buzzer. The central interrogator could further comprise locator software that interrogates an RSSI signal from the golf ball communications circuitry as detected by the central interrogator communications circuitry, compares a location of the central interrogator to the RSSI signal, and calculates a location of the golf ball based on a plurality of central interrogator location and RSSI signal data pairs.

A method for analyzing the performance of a game of golf is also described. The method comprises (1) detecting an impact with an accelerometer, (2) measuring rotation with a spin detector, said spin detector sending a rotation signal to a microprocessor located inside of a golf ball, said microprocessor electrically connected to a communications interface, (3) measuring acceleration with the accelerometer, said accelerometer sending an acceleration signal to the microprocessor, (4) converting the rotation signal into a rotation speed and a rotation direction, said rotation speed determined by a frequency of the rotation signal and said rotation direction determined by a magnitude of the rotation signal, through a calculation in the microprocessor, (5) storing the rotation speed, the rotation direction, and the acceleration signal in a memory electrically connected to the microprocessor; and (6) sending the rotation speed, the rotation direction, and the acceleration signal to the communications interface for transmission to a central interrogator for analysis on a golfer’s performance.

A timestamp could be stored in addition to the rotation speed and the acceleration signal. The timestamp could be sent to the communications interface.

A golf ball with embedded electronics is also described here. The golf ball is made of an accelerometer, a processor electrically connected to the accelerometer, a spin director, communications circuitry, and memory, wherein the processor stores accelerometer data from the accelerometer in the memory. The spin detector directs rotation data regarding rotation of the spin detector to the processor, where the processor converts the rotation data regarding the rotation of the spin detector into a rotation speed and a rotation direction. The rotation speed is determined by the frequency of the rotation data and the rotation direction is determined by the magnitude of the rotation data. This determination is made through a calculation and the rotation speed and said rotation direction are stored in the memory. The communications circuitry is configured to communicate the accelerometer data, the rotation direction, and the rotation speed to a central interrogator for analysis of a golfer’s performance.

In some embodiments, the spin detector is an accelerometer. The communications circuitry could be further configured to communicate exit velocity as calculated by the processor to the central interrogator.

A system is also described here, where the system includes artificial grass with a launch location for a golf ball; a plurality of wide-angle distance optical sensors, mechanically connected to the artificial grass at a known angle to the ground, positioned such that a field of measurement of each wide-angle distance optical sensors intersects; and a central processing unit. The central processing unit is connected to the wide-angle distance optical sensors. The central processing unit is configured to collect distance measurements from the wide-angle distance optical sensors and to determine a velocity of a trajectory of the golf ball from the launch location to the intersection of the field of measurement of each of the wide-angle distance optical sensors given a distance between the plurality of the wide-angle distance optical sensors, a distance between the plurality of the wide-angle distance optical sensors and the launch location, and the distance measurements from the plurality of the wide-angle distance optical sensors. The central processing unit transmits the velocity of the trajectory of the golf ball.

In some embodiments, the central processing unit transmits the velocity of the trajectory of the golf ball to a smartphone. The launch location could be a golf tee. The central processing unit could be configured to calculate a vertical launch angle and/or configured to calculate a horizontal launch angle. The plurality of the wide-angle distance optical sensors could send pulses of light and detect a reflection of the pulses of the light.

A method is also described here, where the method includes the steps of (1) configuring a central processing unit and a memory with a first distance between a first wide-angle distance optical sensor and a second wide-angle distance optical sensor, a second distance between the first wide-angle distance optical sensor, the second wide-angle distance optical sensor, and a launch location; (2) measuring a third distance between the first wide-angle distance optical sensor and a golf ball in flight, and a fourth distance between the second wide-angle distance optical sensor the golf ball in flight; (3) calculating a velocity of a trajectory of the golf ball from the launch location to an intersection of a field of measurement of the first wide-angle distance optical sensor and the second wide-angle distance optical sensor given the first distance, the second distance, the third distance and the fourth distance; and (4) sending the velocity of the trajectory of the golf ball to a display device.

In some embodiments, the display device is a central interrogator. The velocity of the trajectory of the golf ball could be wirelessly sent to the display device. The launch location could be a golf tee. The launch location could be on artificial grass. the first wide-angle distance optical sensor and the second wide-angle distance optical sensor could be mechanically connected to the artificial grass. The first wide-angle distance optical sensor and the second wide-angle distance optical sensor could be electrically connected to the central processing unit. The first wide-angle distance optical sensor could send pulses of light and detect a reflection of the pulses of the light.

The method could further include the step of (3a) calculating a vertical launch angle given the first distance, the second distance, the third distance, and the fourth distance. The method could further include the step of (3b) calculating a horizontal launch angle given the first distance, the second distance, the third distance, and the fourth distance.

A method is described here, the method including the steps of (1) configuring a central processing unit and a memory with a first distance between a first wide-angle distance optical sensor and a second wide-angle distance optical sensor, a second distance between the first wide-angle distance optical sensor, the second wide-angle distance optical sensor, and a launch location; (2) measuring a third distance between the first wide-angle distance optical sensor and a golf ball in flight, and a fourth distance between the second wide-angle distance optical sensor the golf ball in flight; (3) a means for calculating a velocity of a trajectory of the golf ball from the launch location to an intersection of a field of measurement of the first wide-angle distance optical sensor and the second wide-angle distance optical sensor; and (4) sending the velocity of the trajectory of the golf ball to a display device.

The display device could be a laptop computer. The method could further include the step of (3a) a means for calculating a vertical launch angle. The method could further include the step of (3a) a means for calculating a horizontal launch angle.

In some aspects, the techniques described herein relate to a method for determining a spin rate and a spin axes of a golf ball including: collecting a user magnetometer frame of reference vector from a user magnetometer; collecting a user accelerometer frame of reference vector from a user accelerometer; collecting a ball magnetometer frame of reference vector from a ball magnetometer on the golf ball at rest; collecting a ball accelerometer frame of reference vector from a ball accelerometer on the golf ball at rest; calculating frame of rotation coefficients from the user magnetometer frame of reference vector, the user accelerometer frame of reference vector, the ball magnetometer frame of reference vector, and the ball accelerometer frame of reference vector using a Kabsch Algorithm; collecting a ball magnetometer time series matrix from the ball magnetometer as the ball is in flight; processing the ball magnetometer time series through a Rodrigues Rotation Formula using the frame rotation coefficients to create a rotation vector; calculating a prior vector difference and a second prior vector difference; calculating the spin axes by multiplying the prior vector difference by the second prior vector difference; calculating a Theta vector by taking an arccosine of a dividend of a product of the prior vector difference multiplied by the second prior vector difference divided by a product of an absolute value of the prior vector difference multiplied by an absolute value of the second prior vector difference; calculating the spin rate by dividing a change in Theta by the change in time; and displaying the spin rate and the spin axes on a display device.

In some aspects, the techniques described herein relate to a method further includes processing the ball magnetometer time series matrix through an infinite impulse response filter.

In some aspects, the techniques described herein relate to a method further includes processing the spin axes through an infinite impulse response filter.

In some aspects, the techniques described herein relate to a method further includes processing the spin rate through an infinite impulse response filter.

In some aspects, the techniques described herein relate to a method wherein the display device is a central interrogator.

In some aspects, the techniques described herein relate to a method wherein the spin axes and the spin rate are wirelessly sent to the display device.

In some aspects, the techniques described herein relate to a method wherein the user magnetometer is located on a ground near a golf tee.

In some aspects, the techniques described herein relate to a computing apparatus with non-transitory machine-readable media programmed to: collect a user magnetometer frame of reference vector from a user magnetometer; collect a user accelerometer frame of reference vector from a user accelerometer; collect a ball magnetometer frame of reference vector from a ball magnetometer on a golf ball at rest; collect a ball accelerometer frame of reference vector from a ball accelerometer on the golf ball at rest; calculate frame of rotation coefficients from the user magnetometer frame of reference vector, the user accelerometer frame of reference vector, the ball magnetometer frame of reference vector, and the ball accelerometer frame of reference vector using a Kabsch Algorithm; collect a ball magnetometer time series matrix from the ball magnetometer as the ball is in flight; process the ball magnetometer time series through a Rodrigues Rotation Formula using the frame rotation coefficients to create a rotation vector; calculate a prior vector difference and a second prior vector difference; calculate a spin axes by multiplying the prior vector difference by the second prior vector difference; calculate a Theta vector by taking an arccosine of a dividend of a product of the prior vector difference multiplied by the second prior vector difference divided by a product of an absolute value of the prior vector difference multiplied by an absolute value of the second prior vector difference; calculate a spin rate by dividing a change in Theta by the change in time; and display the spin rate and the spin axes on a display device connected to the computing apparatus.

In some aspects, the techniques described herein relate to a computing apparatus further programmed to process the ball magnetometer time series matrix through an infinite impulse response filter.

In some aspects, the techniques described herein relate to a computing apparatus further programmed to process the spin axes through an infinite impulse response filter.

In some aspects, the techniques described herein relate to a computing apparatus further programmed to process the spin rate through an infinite impulse response filter.

In some aspects, the techniques described herein relate to a computing apparatus wherein the display device is a smartphone.

In some aspects, the techniques described herein relate to a computing apparatus wherein the spin axes and the spin rate are wirelessly sent to the display device.

In some aspects, the techniques described herein relate to a computing apparatus wherein the user magnetometer is located on artificial grass, the artificial grass including a launch location for the golf ball.

In some aspects, the techniques described herein relate to a system including: artificial grass including a launch location for a golf ball, a user magnetometer, and a user accelerometer; the golf ball including a wireless interface, a ball magnetometer, and a ball accelerometer; a central processing unit connected to the user magnetometer and the user accelerometer, the central processing unit further including a wireless transceiver wirelessly connected to the wireless interface, wherein the central processing unit creates frame rotation coefficients from data collected from the ball magnetometer, the ball accelerometer, the user magnetometer, and the user accelerometer using a Kabsch Algorithm; where the central processing unit uses a Rodrigues Rotation Formula on the frame rotation coefficients and ball magnetometer data after the golf ball is hit by a golf club, to produce a prior vector difference vector and a second prior vector difference vector; where the central processing unit uses the prior vector difference vector and the second prior vector difference vector to determine a spin axes and a spin rate; and a display device connected to the central processing unit, the display device receives the spin axes and the spin rate from the central processing unit, and displays the spin axes and the spin rate.

In some aspects, the techniques described herein relate to a system where the launch location is a golf tee.

In some aspects, the techniques described herein relate to a system wherein the central processing unit resides in a smartphone.

In some aspects, the techniques described herein relate to a system wherein the spin axes and the spin rate are wirelessly sent to a smartphone.

In some aspects, the techniques described herein relate to a system wherein the ball magnetometer data includes a matrix of X, Y, and Z coordinate data over time.

In some aspects, the techniques described herein relate to a system including: artificial grass including a launch location for a golf ball, a user magnetometer, and a user accelerometer; the golf ball including a wireless interface, a ball magnetometer, and a ball accelerometer; a central processing unit connected to the user magnetometer and the user accelerometer, the central processing unit further including a wireless transceiver wirelessly connected to the wireless interface, wherein the central processing unit includes a means for creating frame rotation coefficients from data collected from the ball magnetometer, the ball accelerometer, the user magnetometer, and the user accelerometer; where the central processing unit includes a means for producing a prior vector difference vector and a second prior vector difference vector from the frame rotation coefficients and ball magnetometer data after the golf ball is hit by a golf club; where the central processing unit includes a means for determining a spin axes and a spin rate from the prior vector difference vector and the second prior vector difference vector; and a display device connected to the central processing unit, the display device receives the spin axes and the spin rate from the central processing unit, and displays the spin axes and the spin rate.

### BRIEF DESCRIPTION OF THE DRAWINGS

FIG. 1 is a partial cross-sectional perspective view of a golf ball including three elements: an innermost core comprised of a high stiffness sphere, a middle mantle layer, and a cover layer.

FIG. 2 is a partial cross-sectional perspective view of a golf ball including four elements: an innermost core comprised of a high stiffness sphere, the electronics in the sphere, a middle mantle layer, and a cover layer.

FIG. 3 shows a cross-section of a golf ball with the various electronic components.

FIG. 4 shows the general relationship of the smartphone to the golf ball in the phone sweeping embodiment.

FIG. 5 shows the signal pool associated with the respective circle segment in the phone sweeping embodiment.

FIG. 6 is a flow chart showing the algorithm for the phone sweeping embodiment.

FIG. 7 is a screenshot of the dashboard of the user interface on the smartphone.

FIG. 8 is a screenshot of the challenges screen on the cell phone app.

FIG. 9 is a screenshot of the play screen.

FIG. 10 is a screenshot of the community screen.

FIG. 11 is a shot of the analysis screen.

FIG. 12 is a 3D grid showing the conventions used in the following Figures.

FIG. 13 is a diagram of the sensors for velocity measurement.

FIG. 14 is a diagram of the sensor placement for launch angle measurement.

FIG. 15 is a diagram of the spin direction measurement technique.

FIG. 16 is an x, z coordinate diagram of the golf ball trajectory showing the launch angle, the distance, and the height.

FIG. 17 is an x, y coordinate diagram of the golf ball trajectory showing the angle of the golf ball trajectory to the left or right of the center and the distance.

FIG. 18 is a y, z coordinate diagram of the golf ball trajectory showing the sensor locations, the height, and the trajectory to the left or right of the center.

FIG. 19 is a flow chart of the steps to determine the characteristics of the golf ball trajectory.

FIG. 20 is an electrical diagram of the calculating unit for processing the sensor data.

FIG. 21 is a diagram showing the frames of reference for the golf ball and for the user.

FIG. 22 is a diagram showing the user frame of reference.

FIG. 23A is a first half of a flow chart showing the determination of the spin axes and the spin rate.

FIG. 23B is a second half of a flow chart showing the determination of the spin axes and the spin rate.

### DETAILED DESCRIPTION

The present inventions describe several embodiments for an improved golf ball, where the gold ball includes hardened electronics and the golf ball comprises an improved material to protect the electronics from the extreme forces that occur when the ball is hit by the club. A software application accompanies the improved golf ball to provide the golfer with an interface to the golf ball data. As stated above, the extreme number of lost golf balls and the inability of golfers to analyze their round impinges on the golfer’s enjoyment of the game. The inventions described here solve this problem.

A golfer’s ball can be found using proximity and tracking using sound. A golfer can view detailed analytics taken from the accelerometer and displayed on a phone via Bluetooth. The technology inside the balls allows them to be found quickly through proximity and sound, and the app gives a golfer helpful analytical data. While Bluetooth is used throughout this document, other communication techniques could be used in place of Bluetooth and BLE.

### Golf Ball Design

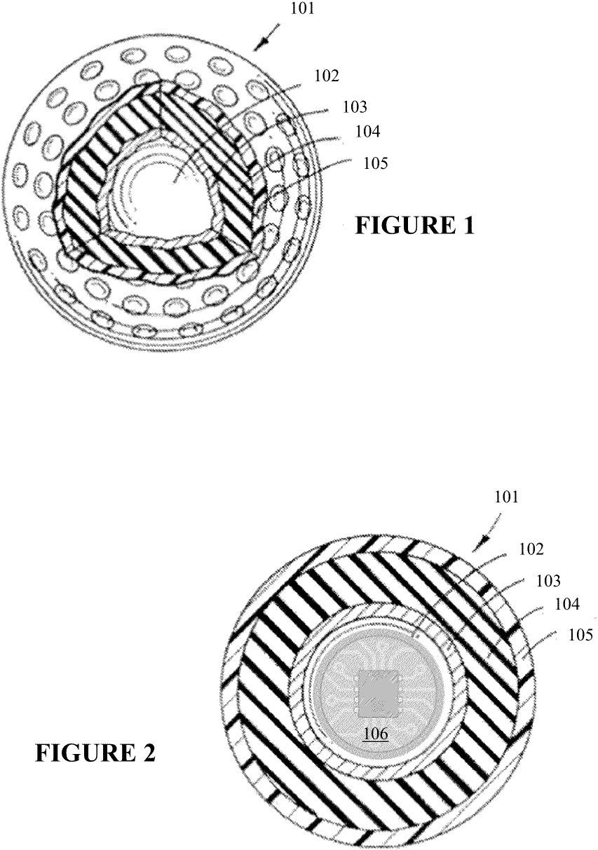

FIG. 1 shows a golf ball 101 that includes a stiff hollow spherical core 102 surrounded by a first polymer layer 103, which forms a two-part spherical body with a surface. The two-part spherical body is surrounded by cover layer 105 that includes dimples or other surface features that are known in the art to improve flight characteristics. The cover layer 105 has an outer surface with dimples and an inner surface opposite of the outer surface that defines a cavity. The outer surface and inner surface of the cover layer 105 together define a cover thickness, which is about 4 mm, but may be any thickness between about 1 mm and about 6 mm, including all values and ranges in-between, or between about 2 mm and about 5 mm. The cover layer 105 with the surface dimple pattern is made of a polymer sold under the trade name SURLYN® (manufactured by DuPont). In another example, the cover layer 105 is made of an ionomer, urethane, balata, polybutadiene, other synthetic elastomers, or any other material suitable for a golf ball cover. The cover layer 105 also forms the golf ball diameter. In one embodiment, the golf ball diameter is approximately 42.67 mm (1.68 inches), but may be any diameter equal to, greater than, or less than 42.67 mm that is capable of play. For example, USGA legal golf balls are 1.68 inches or greater in diameter. For example, the golf ball diameter may be between about 40 mm and about 45 mm, including all values and ranges in between.

The primary spherical core 102 is a polymer matrix composite, metal matrix composite, or carbon matrix composite. The diameter of the spherical core 102 may be any diameter from about 10 mm (0.39 inches) to about 38 mm (1.50 inches), including all values and ranges in-between. For example, USGA legal golf balls with stiff cores have a core diameter less than or equal to 0.9 inches. In an example, the spherical core 102 of the golf ball 101 has a diameter of less than about 31.75 mm (1.25 inches), including all values and ranges in-between. In another example, the spherical core 102 of the golf ball 101 has a diameter less than or equal to about 22.86 mm (0.90 inches). In yet another example, the spherical core 102 has a diameter from approximately 0.9 inches to approximately 0.25 inches. In one embodiment, the spherical core 102 is hollow, providing space to insert a printed circuit board (pc board) 106. In another embodiment, the pc board 106 in the spherical core 102 is surrounded by material 301, such as a polymer urethane visco-elastic material such as Sorbathane to absorb the impact of the golf club striking the golf ball. Sobathane is described in a series of patents awarded to Dr. Maurice Hiles, including US U.S. Pat. 4,101,704, U.S. Pat. 4,346,205, U.S. Pat. 4,476,258, and U.S. Pat. 4,808,469, each of these patents incorporated herein by reference. In other embodiments, the Sorbathane could be replaced with Silicone, Neoprene, Norsorex, Rubber, Deflex, Gelmec, Microsorb, Memory foam, Acoustic foam, or other similar material.

The second layer 104 is a polymer material, such as one or more of ethylene (meth)acrylic acid ionomers (such as DuPont’s HPFTM resin), polyether block amide (such as the material sold under the trade name PEBAX® made by the Arkema Group), polybutadiene, or other materials known the art that are used in golf balls. The second layer 104 can be of molded construction. The second layer 104 generally has an outside diameter of about 1.52 to 1.60 inches (3.86 to 4.06 centimeters) and a thickness of 0.05 to 0.65 inches (0.13 to 1.65 centimeters), including all values and ranges in-between. In another example, the second layer 104 has an outside diameter of about 0.21 to 0.55 inches (0.53 to 1.4 centimeters).

Another embodiment of the improved golf ball 101 is illustrated in FIG. 2. The golf ball 101 includes a stiff spherical core 102, surrounded by a thin first mantle layer 103, surrounded by a second mantle layer 104, and further surrounded by a cover layer 105.

### Golf Ball Circuitry

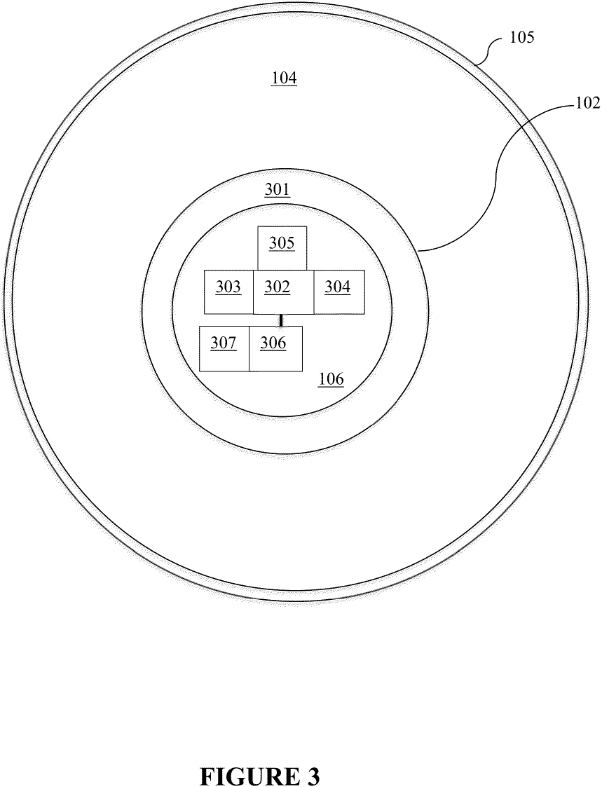

Looking at FIG. 3, the stiff spherical core 102 is surrounded by the second layer 104, and the golf ball cover 105. Inside of the core 102 is a shock-absorbent material 301 such as a polymer urethane visco-elastic material. The shock-absorbent material 301 protects the embedded electronics, possibly mounted on a pc board 106.

The pc board 106 includes a BLE (Bluetooth Low Energy) Chip 302 such as a Nordic nRF52832 or a Cyprus Semiconductor PSOC BLE chip; a QI Wireless Charger chip 307 such as an Analog Devices LTC4124, an Accelerometer 303 such as a 1428-1060-2-ND; one or two Magnetoresistive (MR) Sensors 305, such as a TIDRV5053CAQLPGM; a Battery 306 such as a PD521417 with a power control module and cables; and a Buzzer 304, such as a 102-3746-1-ND. Each of these components are soldered into the PC Board, in one embodiment. The BLE Chip 302 includes memory, communications circuitry, and a microprocessor (BLE processor), as well as circuitry for interfacing with various sensors. In another embodiment, the BLE chip 302 has the power control module, the wireless charger 307, the accelerometer 303, and the MR sensors 305 integrated into a single integrated circuit, either as an ASIC or as a custom chip. Any combination or integration within an integrated circuit and separate components could be used without deviating from the inventions herein. In one embodiment, the components are surface mounted to the pc board, and the board could also be encased in epoxy or silicon to increase its resistance to shock.

The BLE chip 302 is electrically connected to the accelerometer 303 and the MR sensors 305 as is the buzzer 304. The buzzer 304 is optional. The BLE chip 302 includes a processor, a Bluetooth PHY, radio and transponders, RAM and Flash RAM, analog and digital IO interfaces, and power management operations to operate in Bluetooth Lower Energy mode. A BLE antenna is also electrically and mechanically attached to the BLE chip 302 to transmit and receive the BLE signals. This allows the BLE chip 302 to communicate wirelessly with other devices.

The battery 306 is electrically connected to the BLE chip 302 and supplies the appropriate power to the BLE Chip 302. A QI wireless charging chip 307 is also electrically attached to the battery 306. An antenna is also electrically and mechanically attached to the QI chip 307 to receive power signals from a QI charger. Anytime that the antenna receives a usable voltage, the signal is sent to the QI chip 307 for conversion to the appropriate signal levels for recharging the battery. This power signal is then sent to the battery 306.

### Golf Ball Software

When the accelerometer 303 detects that the golf ball 402 is moving, the accelerometer 303 signals the BLE chip 302, located inside of the golf ball 402, to wake up. In an alternative embodiment, the golf ball 402 wakes up when a certain transmission is received on the communications circuitry. In some cases, this movement is the impact of a golf club. In some embodiments, the extent of movement of the golf ball 402 could be calibrated to detect impacts of a golf club but not movement from transportation in a golf bag. Once awake, the golf ball’s 402 BLE chip 302 will stay awake for 30-60 minutes, listening for requests from a smartphone 401. While awake, the BLE chip 302 also monitors the MR sensors 305 and the accelerometer 303 for an indication that the golf ball 402 has been hit by a golf club.

The accelerometer 303 and the MR sensors 305 send signals to the BLE chip 302 which records data from the golf ball 402 from the moment that it is hit until the ball comes to rest. In some embodiments, the signals are sampled at 1 kHz. The accelerometer 303 sends the velocity and acceleration data regarding the activity of the ball. Timers in the BLE chip 302 are used to time the flight of the golf ball. The accelerometer 303 also notes changes in direction from bounces off of the ground or other objects. The MR sensors 305 detect gravity by changing resistance as the gravity changes. The MR sensor signals (data) are sent to the BLE chip 302. This allows the spin of the golf ball to be measured. The frequency of the resistive signal from the MR sensor 305 is the rotational speed, and the magnitude is the direction in which the ball is spinning (rotation direction). A very small magnitude indicates that the spin is almost parallel to the earth, and a high magnitude shows that the spin is perpendicular to the earth. There is a point where the ball is spinning absolutely parallel to the earth where spin cannot be detected. In some embodiments, a second MR sensor 305 is used, where the second MR sensor is mounted 90 degrees offset from the first MR sensor to allow detection of the golf ball spin when the first sensor is spinning parallel to the earth. During flight, the processor in the BLE chip 302 stores the data from the sensors at an interval, perhaps every 100 msec, into a data array. In many embodiments, the data is timestamped with information from the BLE chip 302 timers. Data could be stored internally on the pc board 106 (possibly in the memory of the BLE chip 302) in the form of instantaneous acceleration readings, directly or calculated, from the accelerometer 303 in the x, y, and z directions.

In some embodiments, the accelerometer 303 component blacks out when the golf ball 402 velocity exceeds about 85 miles per hour, making it impossible to calculate its exit velocity through basic physics (v = v0 + at), given that a golf ball 402 may travel 150-200 miles per hour in flight. The data in the period where the accelerometer 303 is blacked out could be ignored (although the timestamps are retained) and extrapolated using available data. A portion of this data comes from the free fall equation. Upon the user indicating that the ball 402 is found, the phone 401 will attempt to connect to the ball 402 and pull the stored data from it.

The raw data is processed, either by the BLE chip 302 in the golf ball 402 of by the phone 401, to remove any erroneous readings due to the accelerometer’s read-ceiling; the accelerometer can only read values to a certain point, once this ceiling is hit, the readings will all be the same until they become lower than the maximum possible read value. This is done by removing any identical readings at the beginning of the array. The original start time is retained, so that the hang time is accurate and so that the initial values can be extrapolated once the best-fit lines are calculated.

Another characteristic of the raw data are outliers on the trendline. Periodically, the accelerometer will produce a reading that is significantly different from the points surrounding it. This isn’t due to an action on the ball, but rather the device sensitivity, environmental factors, etc. surrounding the pc board 106. To reduce the effect of these readings, every 10 data points are averaged out.

From here, any data at the tail end of the array is eliminated if they are deemed to be too similar to each other (for example, having the (x,y,z) reading being within 10 units of each other), indicative of the ball coming to a stop at the end of the shot. The data is also all shifted down to a starting point of (x: 0, y: 0, z: 0, t: 0) for ease of the calculations. Then, from the raw acceleration data, the velocity at each data point is captured using a simple area-under-the-curve calculation.

A linear regression is run on the x, y, and z components of the velocity readings. The regression algorithm comes from “regression-js [,] a JavaScript module containing a collection of linear least-squares fitting methods for simple data analysis. The regression algorithm converts the data into a linear equation

$$Y = a + b X$$

These regression equations are the basis of the analytics calculations. The equations of the analytics are based on a regression package for node.js [1]. Specifically, the analytics are based on the linear least-squares fitting model on the velocity data points. The algorithm starts with the data formatted as an array of pairs of independent and dependent data (i.e.: [[1,1], [2,2], [3,3]...]). Therefore, the velocity data points (originally in the form of {x,y,z,t}) are split into parameters -- resulting in an array of all x values, all y values, all z values, and all t values. The x,y,z arrays are then paired with t and passed to the regression algorithm in succession. The algorithm returns the x-coefficient and the y-intercept of the fitted line, which gets stored as part of the velocity equation for its respective location vector.

Displacement equations are calculated for the x, y, and z vectors by integrating the velocity values following the power rule for integrals.

These two equations are used to calculate all of the following analytics in the x, y, and/or z directions. The resultant vectors are then combined when necessary.

After the parametric equations are calculated from the linear regression, the individual statistics about the shot are calculated using a combination of algebra, trigonometry, and calculus. The velocity equations are integrated to find the displacement equations, and the combination of these equations produce all the analytics shown to the user.

Hang Time. This is just the last reading’s timestamp minus the first reading’s timestamp.

Exit Velocity. This is taken from the velocity parametric equations. The instantaneous velocity is taken from time 0 and they are combined to get the resultant velocity vector.

Launch Angle. This is calculated by combining the x and y parametric equations and then using trigonometry to calculate the launch angle between the XY-plane and the Z-plane.

Apex Height. Since the XY-plane is the vertical plane (if the ball stays in the correct orientation), the apex height is either the x or y displacement curve’s vertex or a combination of the two if the ball doesn’t land with one of those axes ending up vertical.

Carry Distance. Calculated by doing a Reimann sum on the z-plane displacement vector. The accuracy of this is also dependent on the ball remaining in the correct orientation.

The Bluetooth chip 302 transmits this data (the data array) to a smartphone app. The app translates these data points into actionable insights. The app also features a “lost mode” which uses the Bluetooth chip to find proximity and direction to the ball, as well as play a sound with the buzzer. The pieces communicate with a smartphone app via Bluetooth to translate the data into actionable analytical points.

### Golf Ball Location App

An app located on a cellphone 401 is used to communicate over Bluetooth to the golf ball 402. One aspect of the app is to assist in the location of golf balls 402 after they are hit. Initially, the golfer needs to locate the ball 402 within the range of the Bluetooth signal. While BLE claims an outdoor range of 1000 meters, obstacles could decrease the range. For instance, a golf ball 402 at the bottom of a 5-foot deep water hazard will have difficulty pushing the Bluetooth signal through the water. So the golfer needs to walk in the general direction and distance that the ball 402 was hit. Once the app receives the Bluetooth signal from the golf ball 402, the golfer can instruct the ball 402 to activate the buzzer 304, in one embodiment. The golfer could then follow the sound to the golf ball.

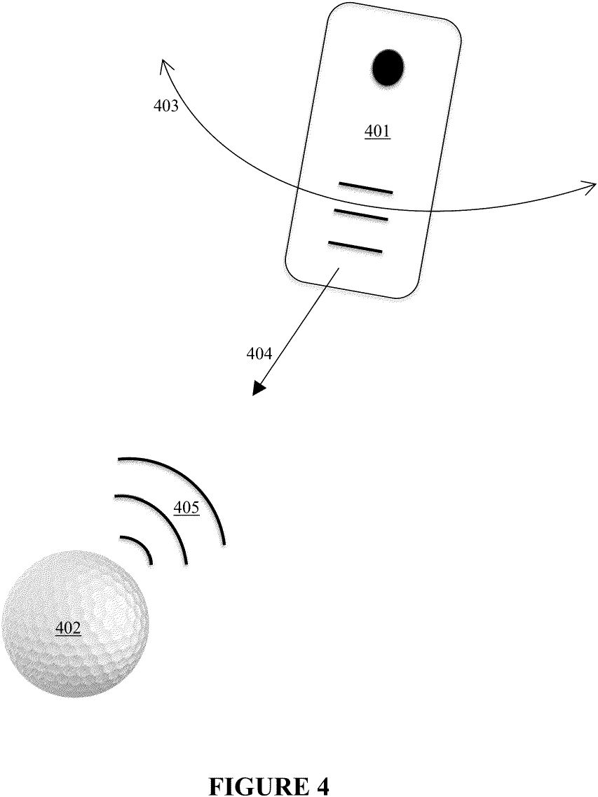

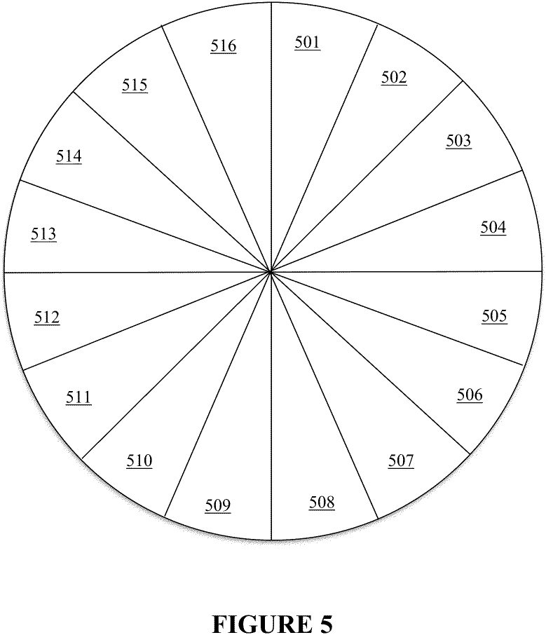

In an alternative embodiment (or in combination with the previous embodiment), the app uses a sweeping motion 403 to create multiple points to use to triangulate the location of the golf ball 402. The sweeping cellphone 401 embodiment describes a method used to locate objects using a cellphone 401. The method relies upon a mobile central interrogator, such as a smartphone 401, and objects 402 with Bluetooth LE (BLE) networking abilities. See FIG. 4.

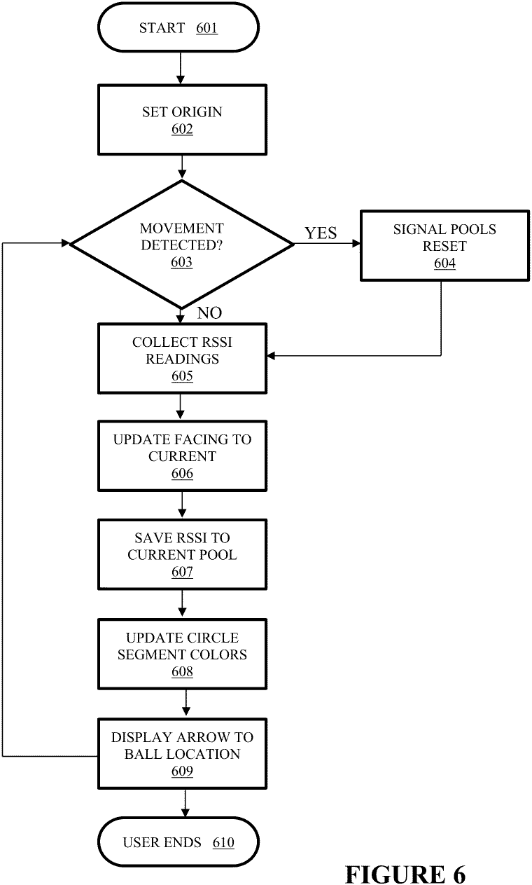

The user holds the central interrogator 401 in his hands and rotates (“sweeps”) 403 it about his body. Using the algorithm in FIG. 6, software on the central interrogating device 401 is able to calculate the direction in which the golf ball 402 lies in two dimensions. The smartphone 401 sees the golf ball 402 location as a vector 404 by detecting the Bluetooth signals 405. The strength of the Bluetooth signal 405 will help with distance calculations. This method does not require a clear line of sight, as BLE signals pass through most objects. Since the method works best in two dimensions, it is best at finding golf balls 402 on the ground and is not ideal at locating balls 402 stuck in trees.

The central interrogator 401 could be a smartphone, a cell phone, a smartwatch, a tablet, a laptop computer, a notebook computer, smart glasses, an augmented reality device, a custom device, or any similar device. In still another embodiment, the central interrogator 401 could be built into a golf cart and display the location information on the windshield of the golf cart. The central interrogator 401 has a processor, a Bluetooth PHY, radio and transponders, RAM and Flash RAM, and a display screen. The central interrogator 401 may have cellular and WiFi capabilities.

### Glossary

RSSI: Received Signal Strength Indicator. A value reported by a device that denotes the current strength of a received radio signal 405 such as Bluetooth Low Energy (BLE). This signal has a range of -100 to -26 decibels (dB).

Signal Pool: A rolling average of RSSI values that keeps track of the lowest and highest values received as well as the difference between the two.

Facing: Facing is the angle of the device relative to a starting position 403. Facing is determined by means of angle data from the device’s 401 gyroscope. When initiated, the gyroscope calibrates its current orientation as the origin (0,0,0) 602. Only the y value (yaw) is taken into consideration when the facing is updated. The facing is used to determine the circle sector to which a particular RSSI reading can be attributed. See FIG. 5.

Heading: The predicted direction in which the user should turn in order to face the signal being tracked. This value is intended to only influence the device’s current yaw value and therefore the user’s Facing direction.

Movement: A change in the user’s position, detected by parsing the weighted moving average of the dot product of each accelerometer readout and the previous readout. The weighted moving average is a normalized value which is calculated as follows:
where A is an accelerometer vector and
N is the number of samples.
MT=movement threshold=0.8
If m>MT, movement has occurred.

### Description of Algorithm

When the user logs into the app and begins a session, whether on- or off-field, they will arrive at a screen prompting them to connect to their golf ball 402. Upon the user’s command, the central interrogator 401 starts broadcasting a beacon to all nearby devices that match the golf ball’s SSID. All available balls are listed, and the user must select their ball 402. Once the selection is made, the central interrogator 401 attempts to connect to the ball 402 via Bluetooth. Post-connection, the user is prompted to tap the button indicating they are ready to play, when they are ready. This prevents the ball from collecting false data from the player setting up to swing.

In FIG. 4, the user holds the central interrogator 401 and moves it in a circular motion 403. Based on yaw data from the accelerometer (in the smartphone 401), the interrogator’s facing 404 is instantaneously updated. For each facing 404, the strength of Bluetooth LE signals 405 received from the golf ball 402 (RSSI) is calculated.

The area surrounding a user is visualized as a circle in FIG. 5 centered at the central interrogator. An array of 16 signal pools 501-516 is allocated, each one associated with a different circle segment. Therefore, each segment is 2π / 16 radians wide (22.5°).

In FIG. 5, RSSI is requested once every second and is added to the signal pool 501-516 associated with the current facing (the gyroscope’s yaw value). When a new RSSI value is added to a signal pool 501-516, the pool will first check for and discard skewed values (a skewed value occurs when abs(RSSI-RSSIavg))>30). Then all signal pools 501-516 are checked to find the pools with the highest RSSI values. If two or more pools share the highest RSSI value, the direction is determined by the pool with the smallest difference between the highest and lowest values.

The direction of the tracked item is indicated to the user as follows. A circle is drawn with a gradient from Red to Green, with red representing the lowest RSSI values with the largest RSSI difference, and green representing the highest RSSI values with the smallest RSSI difference. Colors on a gradient from red to green are drawn at other circle segments representing the relative RSSI values of the surrounding segments.

TABLE 3

| Signal Pool RSSI (Low to High) | Segment Color (RGB) |
|---|---|
| 16 | (255,0,0) |
| 15 | (240, 15, 0) |
| ... | ... |
| 1 | (0, 255, 0) |

Heading arrows are displayed when the user’s facing does not fall within the circle segment with the highest RSSI and lowest signal difference. The direction of the arrow is determined by the dot product of the vector representing the circle segment determined to be the direction of the tag (A̅) and the vector perpendicular to the user’s facing (B̅). If A̅ • B̅>0.4, a right-facing arrow is displayed. If A̅•B̅<-0.4, a left-facing arrow is displayed. For all other values of A̅•B̅, no arrow is displayed. In other words, the display alerts the user to the direction of the tracked item relative to himself.

TABLE 4

| | |
|---|---|
| A̅•B̅ | Display |
| -0.4 or Less | Left arrow |
| Between -0.4 and 0.4 | No arrow |
| Greater than 0.4 | Right arrow |

When movement is detected, the signal pools 501-516 are reset so both the highest and lowest RSSI values are the highest values for that pool.

FIG. 6 shows a flowchart of the algorithm used to determine the location of the object. The flowchart starts 601 by setting the origin to the current gyroscope readings 602. If movement is detected 603, the signal pools are reset 604, and the process collects the RSSI readings 605. If no movement is detected 603, the pools are not reset, and instead, the algorithm proceeds immediately to collect the RSSI readings 605. Then the facing is updated to current 606. The RSSI is saved to the current signal pool 607. Then the circle segment colors are updated 608, and the arrow pointing to the ball direction is displayed 609. The process then repeats, checking for movement 603, until the user ends the process 610.

### Golf Analytics App

A golfer opens our app on their phone 401 after or during a round of to view analytics and insights of their game. They have the ability to see which aspects of their game need the most work and how best to improve it. Golfers can also locate their ball during their round using the app by playing a sound and finding it through proximity and direction.

In some embodiments, once the golfer indicates that they’re ready to take the shot, the phone 401 sends a key code to the ball 402 to start recording accelerometer data. This key code is received by the communications circuitry in the BLE processor 302 on the golf ball 402, and is used to wake up the BLE processor 302.

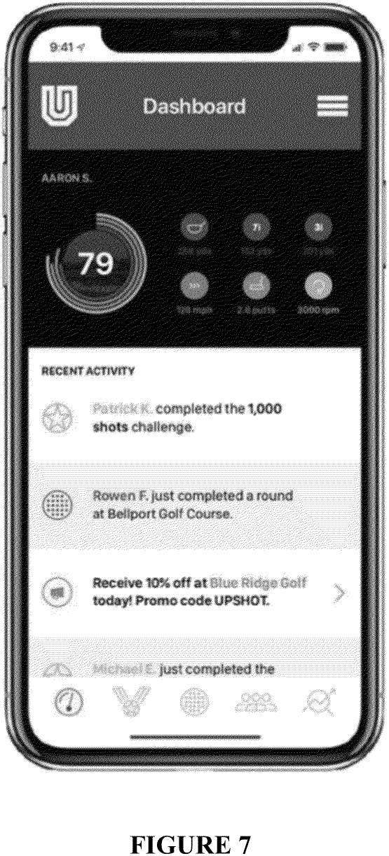

The initial screen for the app can be seen in FIG. 7. The user enters the app with an initial login user interface. The user can either create an account with an email and password or can login with Facebook. If they choose to login with Facebook we will collect the basic info we are allowed to and the list of their Facebook friends who also use the Upshot app. Upon first login, the user is presented with a screen to select the clubs they generally carry with them. This will be called their “golf bag” and can be edited in settings. The dashboard is essentially an upshot golf newsfeed. It contains the Raven score and stats of both the user and community members (friends or people playing the same course); challenges completed by the user and friends; and promotions (primarily for golf equipment). The screen also has statistics on a recent round of golf: the recent wood drive went 258 yards, the 7 iron went 162 yards, and the 3 iron went 201 yards. The ball speed was 128 miles per hour and had a rotation of 3000 rpm. That round took an average of 2.6 putts per hole.

In one embodiment, the rotation of the golf ball is calculated using a gyroscope located inside of the accelerometer 303 mounted on the pc board 106 inside of the golf ball 402. The data from the accelerometer 303 is collected and stored in the memory of the BLE chip 302. Typically, an accelerometer chip 303 with a gyroscope will return the number of degrees of rotation per second in each axis that the gyroscope detects. In some accelerometer chips 303 (the ST Microelectronics LSM6DS3), this number can be detected up to a maximum of 2000 degrees per second, or about 360 rpm. Other accelerometer chips 303 may have larger ranges. Because the accelerometer chip 303 returns the spin in the x, y, and z-axis, the data provides the direction of spin as well.

In a second embodiment, the magnetoresistant sensor (MR) 305 is used to measure changes in the resistivity of a ferromagnetic material carrying a current due to a magnetic field. This technique allows for rotation rates in the tens of thousands of RPMs. The MR sensor returns an analog signal that is the frequency of rotation. This signal could be inputted to a pin on the BLE chip 302 that is configured as a counter to count the number of cycles, a number that corresponds to the rotation of the golf ball 402. The signal from the MR sensor could also be sent to an analog pin on the BLE chip 302 to measure the magnitude of the signal, indicating the direction of spin. By utilizing the Chirp Z-Transform time-frequency domain analysis method based on the rolling window of a Blackman window function we can accurately measure the spin rate of a high g force high spin projectile. This has been tested and proven on 155 mm artillery projectiles. This method is especially effective for high spin & high g projectile launch environments. The MR sensor and the gyroscope, as well as other solutions for detecting and measuring rotation, are referred to as spin detectors 305.

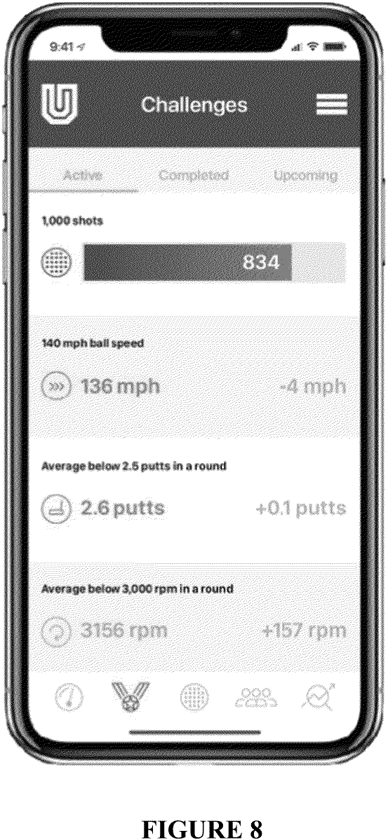

FIG. 8 shows a challenges page containing a series of challenges that can be achieved during a round of golf. “Take 1,000 shots” and “Drive a ball 300 yards” might be some examples of challenges. The page has 3 tabs — active, upcoming, and completed. When a user has taken 150 shots — “Take 100 shots” would be in completed, “Take 1,000 shots” would be in active, and “Take 10,000 shots” would be in upcoming. Statistics on the average ball speed and rotation are displayed, as are the average number of putts in a round.

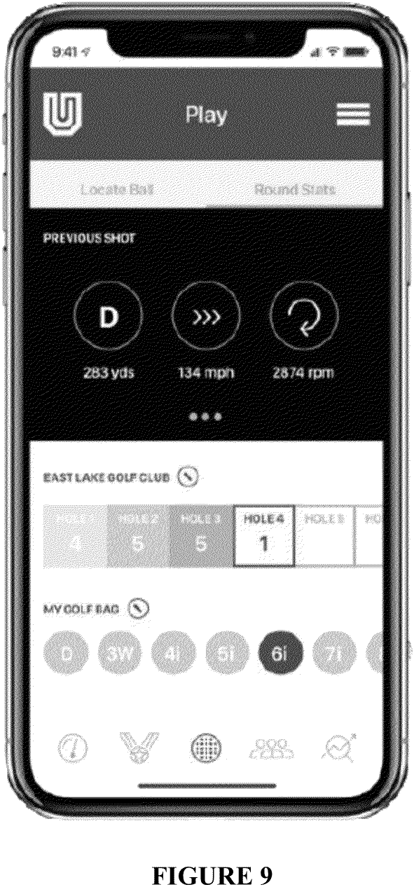

Looking at FIG. 9, the play screen is displayed. The screen consists of two tabs - Round Stats and Ball Locator. The Round Stats shows the user’s current “Raven score”. The Raven Score is calculated by weighting all aspects of a golf shot into a single score. This is comprised of ball velocity, spin rate, spin direction, shots over par, and number of putts. Additional statistics and graphs, such as direction of spin, the force hitting the ball, the height of drive, the trajectory of flight, and the carry could also be displayed. the app also allows the user to select their club for the upcoming shot or to edit the club that was used on past shots. The primary clubs offered to be selected should all be from the user’s “golf bag”. The screen also indicates a predicted scoresheet. Initially, we will not have course data, so the sheet should just show the shots for each hole and not compare to any course-specific information such as what par each hole was.

The Ball Locator works as follows: the user can’t find the ball, and selects the ball finding tab. Based on the metrics we can calculate, we suggest a distance and direction to search. Once within the range of Bluetooth, the user can attempt to “search” for the ball. This triggers the app to attempt a Bluetooth connection with the ball. If it is successful, we can give the user a more precise description of the direction and distance to the ball, using the sweeping algorithm described above. The user could then “ping” the ball when they are near it, which would trigger the sound if the ball is lost in tall grass etc. If the ball cannot be connected via Bluetooth in the original search, then the user is informed they are not close enough to the ball. This shouldn’t occur too often as the Bluetooth should be able to function from a pretty good distance (about ~200 yards).

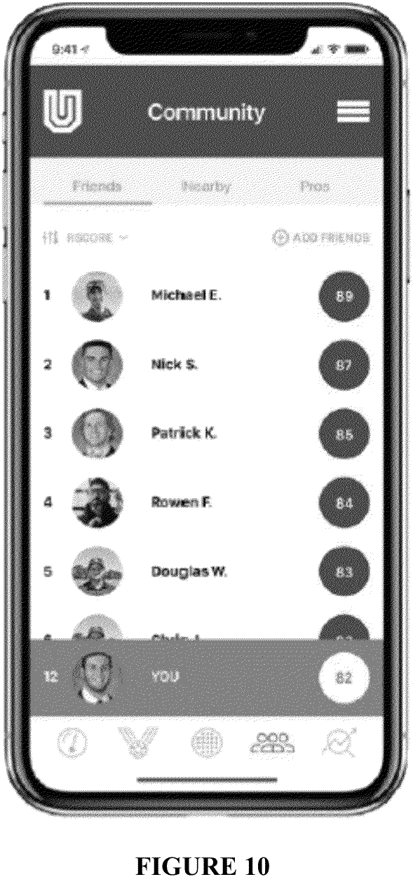

FIG. 10 shows the community page. With this page the user can add friends, if the user is logged in with Facebook then all of their Facebook friends who are using the app should automatically be made their friend on Upshot. It offers the ability to see locals, friends, family, professionals “Raven Score” and allow them to click in to see specific averages. This is all done through the use of the Facebook login SDK. When a user logs in to an app using Facebook, one of the rights that they grant is for the app to see the list of users who are their Facebook friends that have also logged in to the app. Users will have the right to adjust their privacy settings within the app. If a user is on the most visible setting, the app will share their most recent round scores, and other golf statistics, via the community feed. If they are in the most private setting, no data from any of their golf activity will be shared with anyone else using the app.

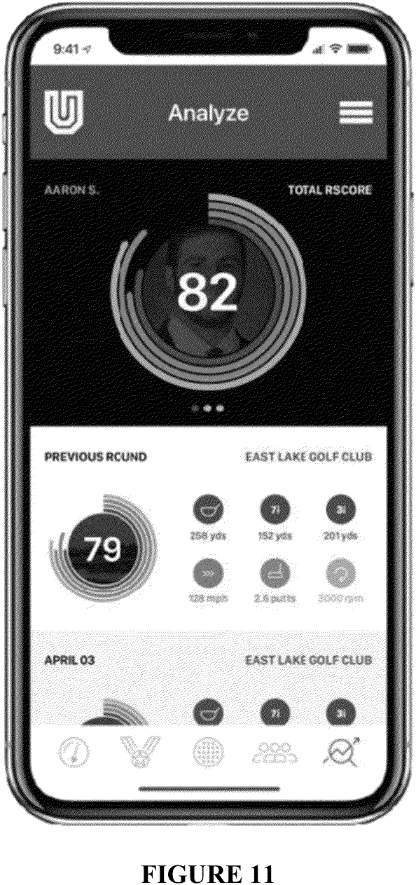

FIG. 11 shows the screen for the analyze screen. With this screen, a user can see their specific rounds and data points from each round, including Average drive, Putts/hole, etc. Tapping a specific round should open a modal containing further analysis: the worst club was X, the weakest part of the game was Y, most improved part of the game was Z. In this screen, the data from the round of golf is analyzed, and compared to the data from other golfers to determine techniques to improve the golf game. These techniques are then suggested to the golfer via the app to improve the golf game. For instance, if the golf ball 402 is showing a topspin, the golfer is advised to adjust his point of striking the ball lower to cause a more direct hit on the ball 402.

The app will aggregate and analyze data from a round to diagnose symptoms of a user’s golf game and provide concise and actionable feedback. Each shot and the corresponding data is labeled with the club that was used. At the completion of a session, all of the shots are sorted by club type. Within each club type, every shot is analyzed for both performance (further distance is better, a 6 iron has an expected spin rate of around 6000 rpm, etc.) and consistency with all of the other shots the user hit with that club. Clubs with the lowest performance and/or consistency ratings are collected along with the top factors that indicate the low performance or consistency. Each data point along with the specific nature of the error is pre-mapped to general feedback about what is likely going wrong and why. The concluding analysis of a session may appear on the screen as follows:
▪ The least efficient club was the 7 iron
▪ 24% of shots were poor due to high spin rate
▪ The average launch angle was ~44% compared to an expected 38%
▪ This suggests an under strike could be occurring in your swing. Y and Z are products/drills that have been shown to help correct this error.

The app may also compute a combined career score based on usage and improvement over time. The user starts at a score of 0 and gains points with each session and challenge completed. Each session awards points based on the number of strokes hit times a multiplier based on how much the user improved an aspect of their game during that time. For example, 100 strokes hit * 1.2 multiplier for correcting the approximate launch angle of the 5 iron = 120 points. Each challenge is assigned a point value in advance. For example, completing a round with under 2.5 putts per hole might be worth 100 points. These scores will then be displayed on a user’s profile and will be used to establish a leaderboard within the social media aspects of the mobile application.

### OPTICAL TIME OF FLIGHT

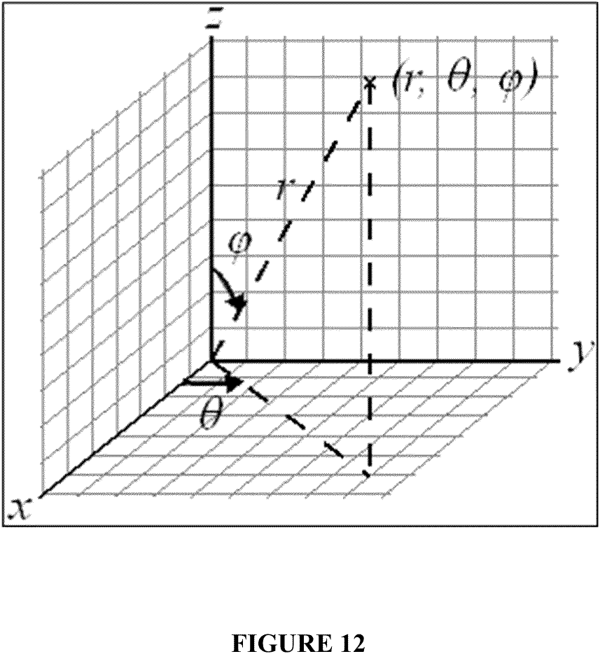

In an alternative set of embodiments, the characteristics of the flight of a golf ball could be calculated using optical sensors and time of flight. Some of these embodiments are seen in FIGS. 12, 13, 14, and 15.

FIG. 12 shows a three-dimensional space on x, y, and z grids. This is shown to outline the conventions used in the following figures. This chart shows an ISO8000-2:2019 right-handed coordinate system. The launch location 1306 is the origin (0,0,0) in the coordinate system. The +X axis is the direction of the ball flight 1312. The +Y is left, from the golfer’s perspective. The +Z axis is up (the Z axis is perpendicular to the ground).

The accuracy of the input data affects the accuracy of the results. For a full swing, if the exit velocity is less than or equal to 100 m/s (223.7 MPH), then a ±5% or ±5 m/s(11.18 MPH) variance results in a ±5% variance in the results or about between ±50 to ± 25 yards variation assuming a fixed launch angle and spin rate. With a spin rate less than or equal to 10,000 RPM (±5% or ±500 RPM), the ±5% variance results in very little variation in the carry distance. The spin direction (axes of rotation) of ±2° results in about ± 3 yards of left or right variation at 200 yards. The variance is negligible for putting.

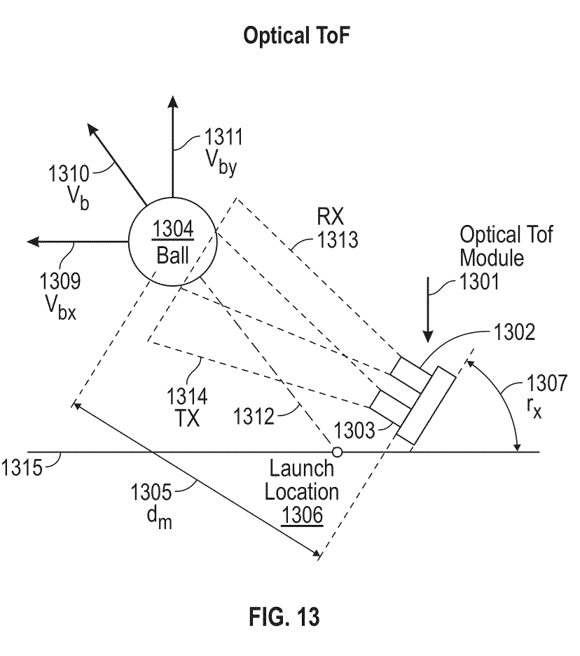

FIG. 13 shows an optical time of flight sensor 1301 as it determines the velocity of the golf ball’s flight. In some embodiments, the flight sensor 1301 is a Texas Instruments TIDA-010021 wide-range (120° FoV at 1.6 meters) proximity sensing reference design with immunity to sunlight optical time-of-flight sensor. Optical time of flight sensor 1301 is made up of an optical source 1302 and a light detector 1303. The optical source 1302 sends a plurality of light pulses 1313 to the golf ball 1304, and as the light pulses 1313 reflect off of the golf ball 1304 as reflections 1314, the reflections 1314are detected by the light detector 1303. The time of the light pulses 1313 is subtracted from the time the reflections 1314 are detected, and the distance 1305 of the golf ball 1304 is calculated. Given a plurality of distance 1305 calculations, the ball velocity V_{b} 1310 is determined. With the incline angle 1307 of the flight sensor 1301 relative to the ground 1315, the velocity in the x direction V_{bx} 1309 and the velocity in the y direction V_{by} 1311 can also be calculated. With these data points, the trajectory 1312 of the golf ball 1304 can be determined from the launch location 1306.

The optical time of flight mechanism can be used for full swing and putting applications. The flight sensor 1301 sends a light pulse 1313 and golf ball 1304 reflects reflections 1314 back. The time that it takes the light pulses 1313 and reflections 1314 to return is measured and distance 1305 is calculated. Using at least two samples of distance 1305 we can then calculate velocity V_{b} 1310, given the incline angle 1307. This device can measure both the club and the ball velocity.

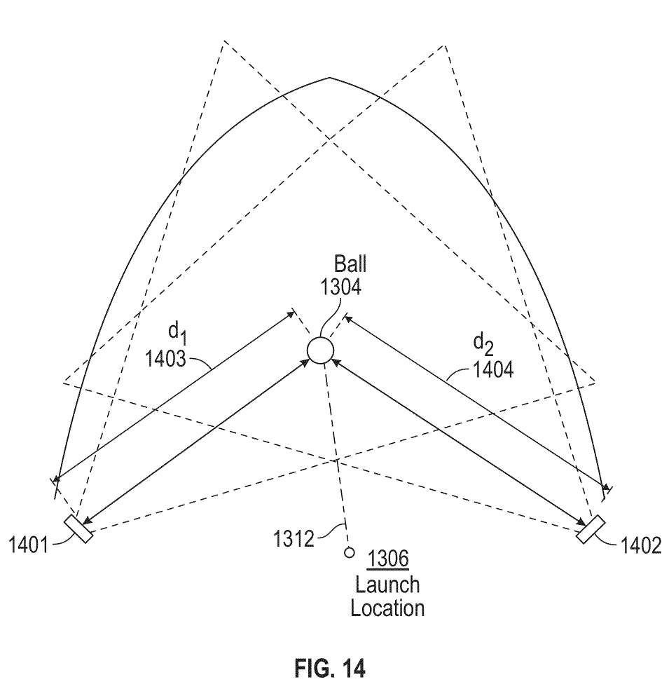

FIG. 14 shows a technique for determining launch angle using wide-angle distance optical sensors 1401,1402. First distance dx 1403 and second distance dy 1404 are measured by sending pulses of light and detecting the reflection, as described above for the flight sensor 1301. In some embodiments, flight sensor 1301 is the same device as the first wide-angle distance optical sensor 1401 and/or second wide-angle distance optical sensor 1402. In other embodiments, the first wide-angle distance optical sensor 1401 and the second wide-angle distance optical sensor 1402 are additional sensors to the flight sensor 1301. In some embodiments, the field of measurement of the first wide-angle distance optical sensor 1401 and the field of measurement of the second wide-angle distance optical sensor 1402 intersect at an intersection point.

Once the first distance dx 1403 and second distance dy 1404 are known the ball can be located within the 2D plane (the ground 1315). If the distance 1305 calculated by the flight sensor 1301 is also included in the calculation (and flight sensor 1301, first wide-angle distance optical sensor 1401, and second wide-angle distance optical sensor 1402 are not in the same plane as the trajectory 1312), then the location of the golf ball 1304 can be determined at a point in time, and over a plurality of location calculations, the launch angle of the golf ball 1304 can be determined from the launch location 1306.

In some embodiments, the angle of the first wide-angle distance optical sensor 1401 and the second wide-angle distance optical sensor 1402 is 45 degrees, although the angle can be varied, provided that the angle is known.

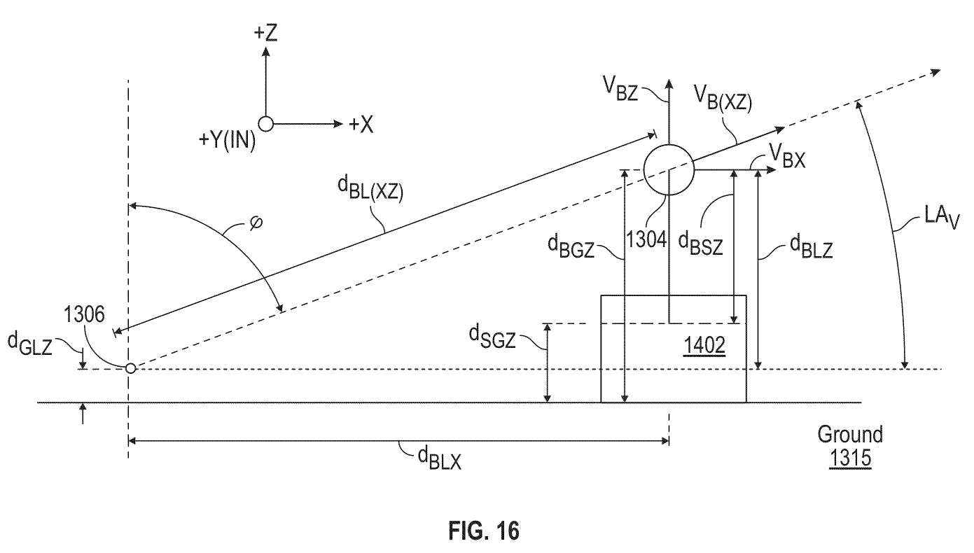

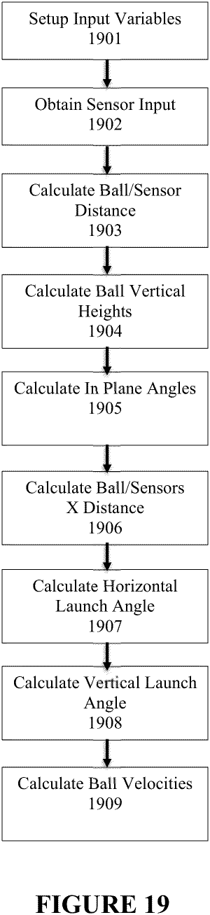

FIG. 14 is described in additional detail in FIGS. 16, 17, and 18 with the corresponding description below. FIG. 19 and its explanation below outline the steps to use the FIG. 14 sensor configuration to calculate the golf ball trajectory characteristics.

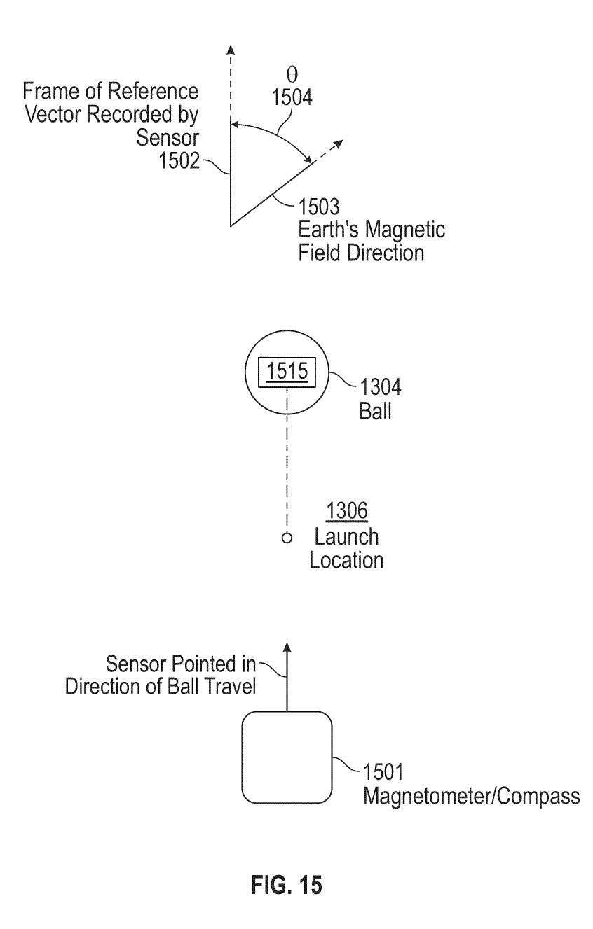

FIG. 15 shows the use of an external magnetometer sensor 1501 to determine the spin direction of the golf ball 1304. An external magnetometer sensor 1501 external to the golf ball 1304 is statically located nearby the launch location 1306. The external magnetometer sensor 1501 orientation relative to the golf ball 1304 direction of flight must be known. An internal magnetometer sensor 1505 is located in golf ball 1304. The internal magnetometer sensor 1505 senses the earth’s magnetic field 1503. The external magnetometer sensor 1501 samples the earth’s magnetic field 1503 and compares this to the internal magnetometer sensor’s 1505 calculation of the s magnetic field 1503. From this comparison, a frame of reference axis 1502 is generated in the direction of ball flight that has known offsets to the earth’s magnetic field 1503 (this is seen as angle θ 1504). The reference axis 1502 becomes the axes in which spin direction is referenced.

In some embodiments, the flight sensor 1301, the first wide-angle distance optical sensor 1401, the second wide-angle distance optical sensor 1402, and the external magnetometer sensor 1501 are installed on a section of artificial grass (such as AstroTurf). A golfer installs the artificial grass and drives the golf ball 1304 from a launch location 1306 on the artificial grass. The systems of sensors then calculates the golf ball 1304 trajectory, launch velocities, angle, spin rate, spin angle, and travel distance.

FIG. 16 is an x, z coordinate diagram of the golf ball trajectory showing the launch angle, the distance, and the height for the sensor configuration shown in FIG. 14. The x-axis is seen along the ground 1315. The golf ball 1304 is shown from the launch location 1306 past the second wide-angle distance optical sensor 1402 and the first wide-angle distance optical sensor 1401. As the golf ball 1304 passes the second wide-angle distance optical sensor 1402, the right sensor measurement d_{S}(_{R}) distance between the second wide-angle distance optical sensor 1402 and the golf ball 1304 is determined. Similarly, as the golf ball 1304 passes the first wide-angle distance optical sensor 1401, the left sensor measurement d_{S}(_{L}) distance between the first wide-angle distance optical sensor 1401 and the golf ball 1304 is determined. The sensors peak difference t_{SP} is also read from the first wide-angle distance optical sensor 1401 and the second wide-angle distance optical sensor 1402. With this input, the ball vertical height d_{BLZ} above the golf tee is calculated as is the launch angle LA_{V}.

FIG. 16 also shows the distance d_{GLZ} between the launch location 1306 and the ground 1315 (also known as the golf tee height). The distance from the second wide-angle distance optical sensor 1402 to the ground is shown as d_{SGZ.} With this data, the distance d_{BZG} between the golf ball 1304 and the ground 1315 is calculated (also known as the height of the ball as it passes the second wide-angle distance optical sensor 1402). The height d_{BSZ} of the golf ball 1304 above the sensor can also be calculated.

The distance d_{BLX} between the launch location 1306 and the second wide-angle distance optical sensor 1402 is measured as an input parameter. Given the launch angle LAᵥ the angle φ is calculated by subtracting from 90°, and the distance d_{BL(XZ)} that the ball travels can also be calculated. These figures are used to calculate the golf ball 1304 velocity V_{B(XZ)}, the vertical velocity V_{BZ}, and the horizontal velocity V_{BX}.

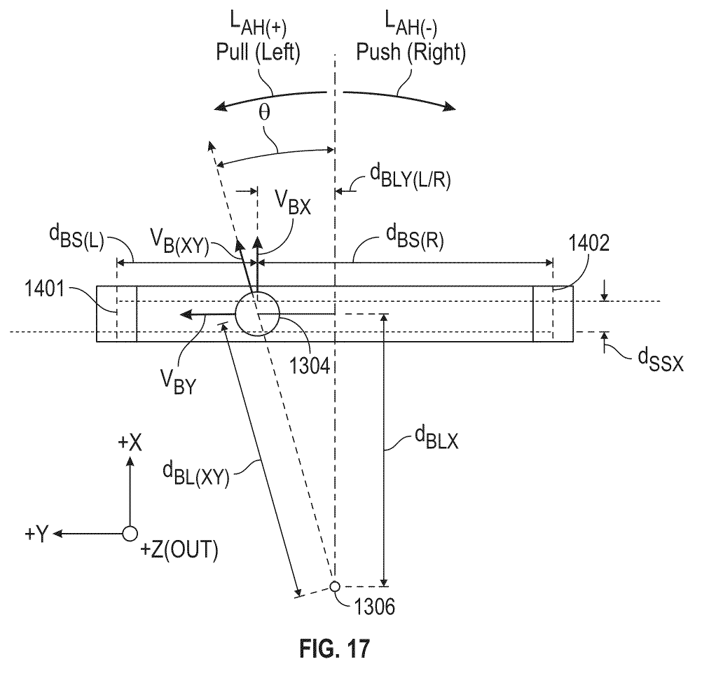

FIG. 17 is an x, y coordinate diagram of the golf ball trajectory showing the angle of the golf ball trajectory to the left or right of the center and the distance for the sensor configuration shown in FIG. 14. In this figure, the ground 1315 is the plane upon which this drawing is shown. The golf ball 1304 is driven from the launch location 1306 by the golfer past the first wide-angle distance optical sensor 1401 and the second wide-angle distance optical sensor 1402. In this example, the golf ball 1304 is pulled to the left L_{AH}(+) by θ degrees. The golf ball 1304 has a distance as it passes the sensors of d_{BS(L)} on the left side and d_{BS(R)} on the right side, which is used to calculate a side velocity V_{BY}, and the distance off of the center line at the sensors d_{BLY(L/R}). Knowing the distance d_{BLX} from the launch location 1306 to a line between the first wide-angle distance optical sensor 1401 and the second wide-angle distance optical sensor 1402 and the angle θ, the distance to the line d_{BL(XY)} can be calculated as well as the velocity in the x direction V_{Bx.}

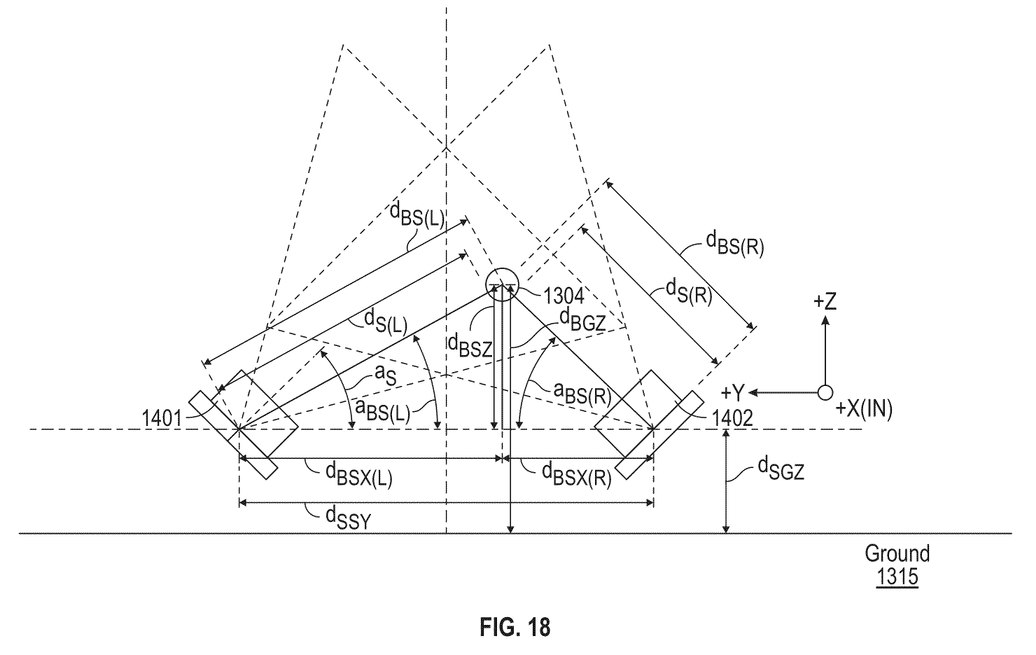

FIG. 18 is a y, z coordinate diagram of the golf ball trajectory showing the sensor locations, the height, and the trajectory to the left or right of the center for the sensor configuration shown in FIG. 14. The first wide-angle distance optical sensor 1401 and the second wide-angle distance optical sensor 1402 senses the golf ball 1304 passing them. The ground 1315 is at the bottom of the diagram.

FIG. 18 shows the first wide-angle distance optical sensor 1401 and second wide-angle distance optical sensor 1402 characteristics, such as the height from the ground d_{SGZ}, angle as relative to the ground, and distance between the sensors d_{SSY}. The first wide-angle distance optical sensor 1401 determines the distance d_{S(L)} to the golf ball 1304, and knowing the radius of the golf ball 1304 r_{B} calculates the distance d_{BS(L)} to the center of the golf ball 1304. The second wide-angle distance optical sensor 1402 determines the distance d_{S(R)} to the golf ball 1304, and knowing the radius of the golf ball 1304 r_{B} calculates the distance d_{BS(R)} to the center of the golf ball 1304. Given the two distances d_{BS(L),} d_{BS(R)} to the center of the golf ball 1304, the height of the golf ball 1304 to the first wide-angle distance optical sensor 1401 height d_{BSZ} can be calculated as well as the height d_{BGZ} from the ground. The split of the distance d_{BSX(L)} and d_{BSX(R)} between the sensors d_{SSY} can also be calculated. The angle a_{BS(L)} of the golf ball 1304 from the first wide-angle distance optical sensor 1401 is also calculated, as is the angle a_{BS(R)} of the golf ball 1304 from the second wide-angle distance optical sensor 1402.

FIG. 19 is a flow chart of the steps to determine the characteristics of the golf ball trajectory for the sensor configuration shown in FIG. 14.

First of all, the setup input variables 1901 are input. These values are constants and determined by measurement at the setup of the system. An example is seen in TABLE 5.

TABLE 5

| Ball Diameter [mm] | Sensor Angle (aS)[Deg] | Sensor Separation Y (d_{SSY}) [mm] | Sensor/Launch X Offset (d_{BLX})[mm] |
|---|---|---|---|
| 42.7 | 45 | 405 | 215.9 |
| Ball Radius (r_{B}) [mm] | Sensor Angle (aS)[Rad] | Sensor Separation X (d_{SSX}) [mm] | Launch/Ground Z Offset (d_{GLZ})[mm] |
| 21.35 | 0.785 | 13.4 | 31.35 |
| Tee Height [mm] Distance from ground to top of the golf tee | | Sensor/Ground Z Offset (dSGZ) [mm] | |
| 10 | | 62 | |

Next, the first wide-angle distance optical sensor 1401, and the second wide-angle distance optical sensor 1402 take the distance measurements and the sensor peak differences 1902. An example is seen in TABLE 6.

TABLE 6

| Left Sensor Measurement (dS(L))[mm] | Right Sensor Measurement (dS(R))[mm] | Sensor Peak Diff (tSP) [Sec] |
|---|---|---|
| 190 | 220 | 1.00E-03 |

The next step is to calculate the distance between the ball and the sensor 1903. The formula is:

$${d}_{B S \left(L / R\right)} = {d}_{s \left(L / R\right)} + {r}_{B}$$

And the resulting data is seen in TABLE 7:

TABLE 7

| Left Ball/Sensor Distance (d_{BS(L)})[mm] | Right Ball/Sensor Distance (d_{BS(R)})[mm] |
|---|---|
| 211.35 | 241.35 |

The following step calculates the golf ball’s vertical heights using the following formulas 1904Eric Goo:

$$s = \frac{{d}_{B S \left(L\right)} + {d}_{B S \left(R\right)} + {d}_{S S Y}}{2}$$

$$s e n s e a r e a = \sqrt{s \left(s - {d}_{B S \left(L\right)}\right) \left(s - {d}_{B S \left(R\right)}\right) \left(s - {d}_{S S Y}\right)}$$

$${d}_{B G Z} = {d}_{B S Z} + {d}_{S G Z}$$

$${d}_{B S Z} = \frac{2 ∗ s e n s e a r e a}{{b}_{S S Y}}$$

$${d}_{B L Z} = {d}_{B G Z} - {d}_{G L Z}$$

The results from the data set used in the example above can be seen in TABLE 8.

TABLE 8

| s | sense area [mm²] | Ball/Sensor Z Offset (dBSZ)[mm] |
|---|---|---|
| 428.85 | 20,423 | 100.856 |
| | Ball/Launch Z Offset (d_{BLZ})[mm] | Ball/Ground Z Offset (d_{BGZ})[mm] |
| | 131.51 | 162.86 |

The fifth step calculates the plane angles a_{BS(L} _{or R)} 1905.

$${a}_{B S \left(L\right)} = A C O S \left(\frac{{d}_{B S \left(L\right)}^{2} + {d}_{S S Y}^{2} - {d}_{B S \left(R\right)}^{2}}{2 {d}_{B S \left(L\right)} {d}_{S S Y}}\right)$$

$${a}_{B S \left(R\right)} = A C O S \left(\frac{{d}_{B S \left(R\right)}^{2} + {d}_{S S Y}^{2} - {d}_{B S \left(L\right)}^{2}}{2 {d}_{B S \left(R\right)} {d}_{S S Y}}\right)$$

Giving the results seen in TABLE 9:

TABLE 9

| Left Angle Sensor/Ball (a_{BS(L)})[rad] | Right Angle Sensor/Ball (a_{BS(R)})[rad] |
|---|---|
| 0.497 | 0.431 |
| Left Angle Sensor/Ball (a_{BS(L)})[deg] | Right Angle Sensor/Ball (a_{BS(R)})[deg] |
| 28.503 | 24.701 |

Then the ball to sensor X distances are calculated 1906:

$$a = {d}_{B S \left(L / R\right)} ∗ S I N \left({a}_{B S \left(L / R\right)}\right)$$

$${d}_{B S X \left(L / R\right)} = \sqrt{{d}_{B S \left(L / R\right)}^{2} - {a}^{2}}$$

And the results are seen in TABLE 10:

TABLE 10

| Left “a” leg [mm] | Right “a” leg [mm] |
|---|---|
| 100.856 | 100.856 |
| Left Ball/Sensor Distance (d_{BSX(L)})[mm] | Right Ball/Sensor Distance (d_{BSX(R)})[mm] |
| 185.733 | 219.267 |

Step 1907 calculates the horizontal launch angle and azimuth. Note that in these calculations a positive number is to the left of the center line and a negative number is to the right of the center line. Golf standards typically use the opposite of this convention, and the sign of the results may need to be reversed for user display.

$${d}_{B L Y} = \frac{{d}_{S S Y}}{2} - {d}_{B S X \left(L\right)} = {d}_{B S X \left(R\right)} - \frac{{d}_{S S Y}}{2}$$

$${d}_{B L} = \sqrt{{d}_{B L Y}^{2} + {d}_{B L X}^{2}}$$

$$θ = A S I N \left(\frac{{d}_{B L Y}}{{d}_{B L \left(X Y\right)}}\right)$$

$$i f \left(f \left(θ\right)\right) = \left\{\begin{matrix}S T R A I G H T , θ \pm 1.5 ° \\ P U S H \left(R I G H T\right) , θ < 1.5 ° \\ P U L L \left(L E F T\right) , θ > 1.5 °\end{matrix}\right)$$

In the example above, these formulas provide the following results (TABLE 11).

TABLE 11

| Ball/Center Line Offset (d_{BLY})[mm] | Ball/Launch Distance ‘Horizontal Plane XY’ (d_{BL(XY)})[mm] |
|---|---|
| 16.767 | 216.550 |
| Horizontal Launch Angle (θ)[rad] | STRAIGHT MARGIN [Deg] |
| 0.078 | 1.500 |
| Horizontal Launch Angle(Azimuth) (θ/LA_{H})[deg] | Hit Direction [Pull/Push] |
| 4.441 | PULL |

Next, in step 1908, the vertical launch angle is calculated:

$${d}_{B L \left(X Z\right)} = \sqrt{{d}_{B L X}^{2} + {d}_{B L Z}^{2}}$$

$$L {A}_{V} = A S I N \left(\frac{{d}_{B L Z}}{{d}_{B L \left(X Z\right)}}\right)$$

This gives the results in TABLE 12:

TABLE 12

| Vertical Launch Angle (LA_{V})[rad] | Ball/Launch Distance ‘Vertical Plane XZ’ (d_{BL(XZ)})[mm] |
|---|---|
| 0.547 | 252.798 |
| Vertical Launch Angle (LA_{V})[deg] | |
| 31.346 | |

Given all of the above calculations and results, the ball velocities can now be calculated in step 1909.

$${V}_{B X} = \frac{{d}_{S S X}}{{t}_{S P}}$$

$${V}_{B Z} = \sqrt{{V}_{B \left(X Z\right)}^{2} - {V}_{B X}^{2}}$$

$${V}_{B Y} = \left\{\begin{matrix}0 , θ = 0 \\ \sqrt{{V}_{B \left(X Y\right)}^{2} - {V}_{B X}^{2}} , θ > 0 \\ - \sqrt{{V}_{B \left(X Y\right)}^{2} - {V}_{B X}^{2}} , θ < 0\end{matrix}\right)$$

$${V}_{B} = \sqrt{{V}_{B X}^{2} + {V}_{B Y}^{2} + {V}_{B Z}^{2}}$$

This provides the final results in TABLE 13:

TABLE 13

| | XY & XZ Projected | | |
|---|---|---|---|
| | Bell Velocity (V_{B(XY)})[m/s] | Bell Velocity (V_{B(XZ)})[m/s] | |
| | 13.44 | 15.69 | |
| Ball Velocity X (V_{BX})[m/s] | Ball Velocity Y (V_{BY})[m/s] | Ball Velocity Z (V_{BZ})[m/s] | Ball Velocity (V_{B})[m/s] |
| 13.40 | 1.04 | 8.16 | 15.72 |
| Ball Velocity X (V_{BX})[mph] | Ball Velocity Y (V_{BY})[mph] | Ball Velocity Z (V_{BZ})[mph] | Ball Velocity (V_{B})[mph] |
| 29.97 | 2.33 | 18.26 | 35.17 |

The results of these calculations are then displayed on the screen for the golfer to review, on a screen similar to the one shown in FIG. 8.

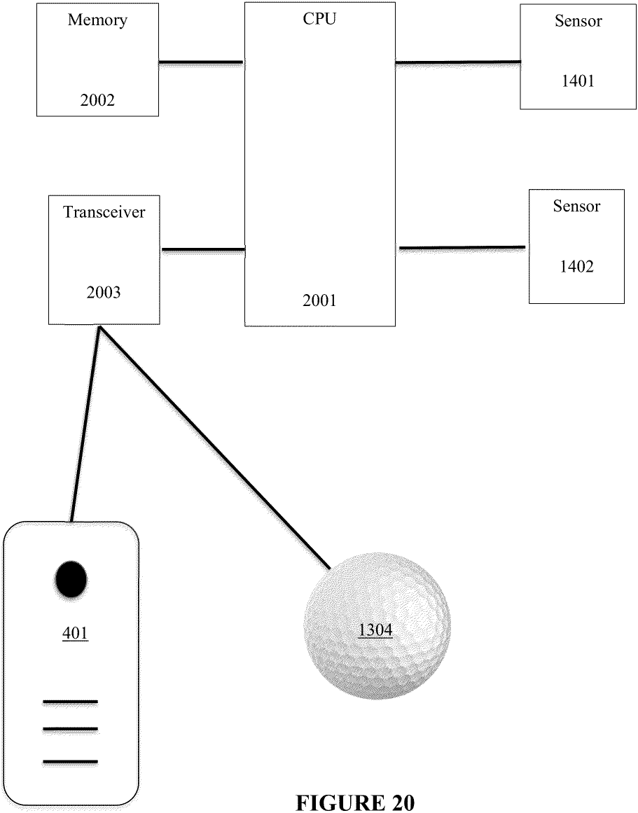

FIG. 20 shows one possible electrical embodiment to implement the algorithms discussed above. The first wide-angle distance optical sensor 1401 and the second wide-angle distance optical sensor 1402 are connected (optically, electrically, or wirelessly) to a central processing unit 2001 (which could be a microprocessor, an ASIC, etc). The central processing unit 2001 configures the first wide-angle distance optical sensor 1401 and the second wide-angle distance optical sensor 1402 and receives data from the sensors. The central processing unit 2001 could execute code (non-transitory machine-readable instructions) to calculate the algorithms and formulas listed above. In another embodiment, the code to calculate the algorithms and formulas could be on a central interrogator 401, or even in golf ball 1304. The central processing unit 2001 is electrically connected to the memory 2002 and to a transceiver 2003. The transceiver 2003 could wirelessly communicate with the central interrogator 401 and/or golf ball 1304. These wireless communications could be Bluetooth, WiFi, cellular, or similar communications technology. In some cases, the central processing unit 2001, memory 2002, and transceiver 2003 could reside in a laptop, a tablet, a desktop computer, a server, a cloud-based computing device, an embedded computing device, etc. In some embodiments, the central processing unit 2001 has a computer display and one or more input devices such as keyboards, mice, touchscreens, etc. In other embodiments, the central processing unit 2001 transmits the data to a display device.

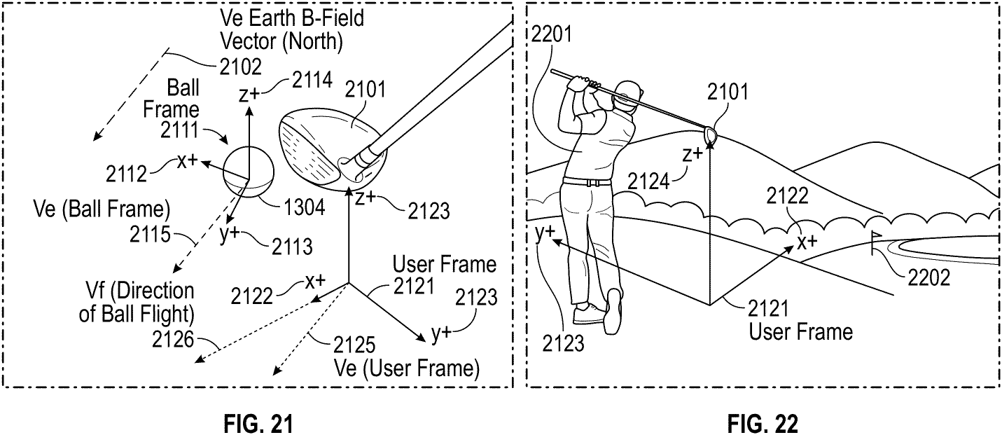

FIG. 21 shows the user frame of reference 2121 and the golf ball 1304 frame of reference 2111. The user frame of reference 2121 and the ball frame of reference 2111 are relative to Vₑ the earth’s magnetic B-field vector 2102 pointing towards the magnetic north. The user frame of reference 2121 has five components: its Cartesian coordinates X+ 2122, Y+ 2123, and Z+ 2124, the user frame vector Vₑ 2125, and the vector of the ball flight V_{f} 2126. The ball frame of reference 2111 has four components: its Cartesian coordinates X+ 2112, Y+ 2113, and Z+ 2114, and the ball frame vector Vₑ 2115. The user frame of reference 2121 is the location of the golf club head 2101 at the point of initial impact with the golf ball 1304.

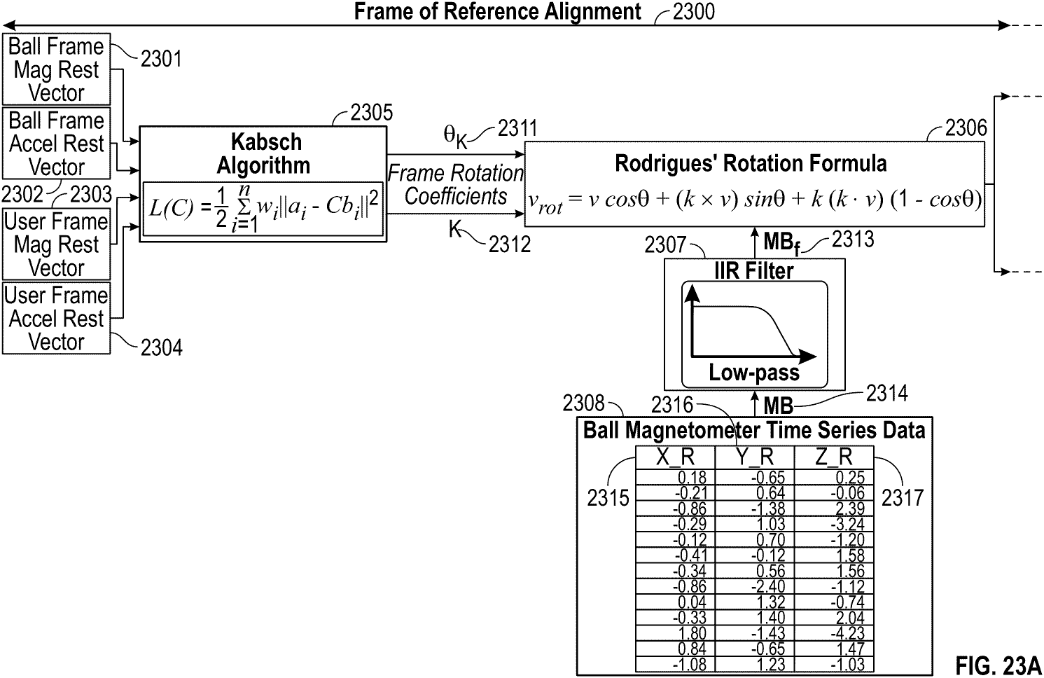

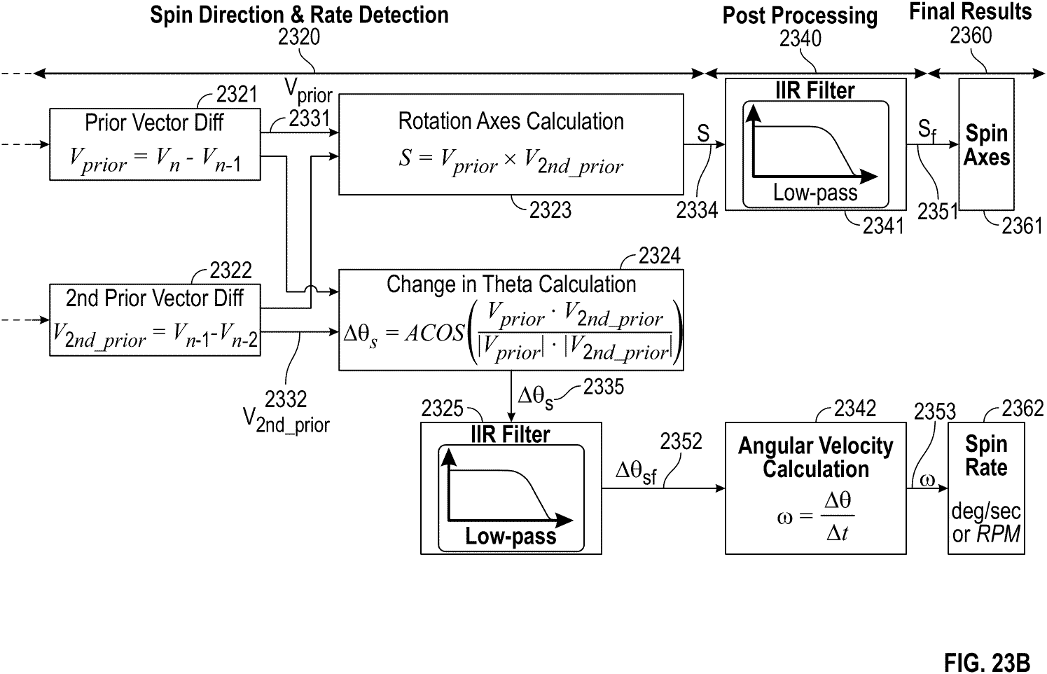

FIG. 22 shows another view of the user frame of reference 2121. This view shows the golfer 2201 holding a golf club with a golf club head 2101 after hitting the golf ball 1304, as the golf ball 1304 moves towards the hole 2202. These frames of reference are inputs to the calculations in FIGS. 23A and 23B. The calculations are stored in a non-transitory computer-readable media, perhaps on the smartphone 401 or in the memory 2002. The smartphone 401 or the CPU 2001 could be programmed to read the non-transitory computer-readable media and to execute the instructions, as outlined in the flow charts in FIGS. 23A and 23B.

FIG. 23A starts with the input of the golf ball 1304 frame of reference 2111 vector 2115 from the magnetometer MR sensors 305 when the golf ball 1304 is at rest 2301 for a period of time n. The golf ball 1304 frame of reference 2111 vector 2115 from the accelerometer 303 for the golf ball 1304 at rest 2302 for a period of time n is also input. The golf ball 1304 vector 2115 is an array of the MR sensor 305 values and the accelerometer 303 values.

The input of the golfer 2201 frame of reference 2121 vector 2125 from the external magnetometer sensor 1501 before the golf ball 1304 is hit 2303 for a period of time n. The golfer 2201 frame of reference 2121 vector 2125 from an accelerometer on the artificial grass for the golf ball 1304 at rest 2304 is also input. The golfer 2201 vector 2125 is an array of the external magnetometer sensor 1501 values and the grass accelerometer values.

These input vectors 2115,2125 are then run through the Kabsch Algorithm 2305 to define the relationship of the golf ball frame of reference 2111 to the golfer frame of reference 2121. The Kabsch algorithm 2305 is a method for calculating the optimal rotation matrix that minimizes the RMSD (root mean squared deviation) between two paired sets of points. The Kabsch algorithm 2305 works in three steps: a translation, the computation of a covariance matrix, and the computation of the optimal rotation matrix.

The specific Kabash algorithm 2305 takes the sum over the number of samples n of the product of a weight assigned to each vector pair wᵢ multiplied by the square of the absolute value of the vector element from the difference of the first frame aᵢ and the product of the rotational matrix C and the second frame bᵢ. In one embodiment, each value in the weight vector w is set to one. a and b can be any number of vectors, in one embodiment, two vectors per frame are used: the vectors for the magnetometer and acceleration. These vectors could be mapped to:

| | |
|---|---|
| a1 | acceleration user frame 2304 |
| a2 | magnetometer 1501 user frame 2303 |
| b1 | acceleration 303 ball frame 2302 |
| b2 | magnetometer 305 ball frame 2301 |

The Kabsch algorithm 2305 produces K, the frame rotation axis vector 2312, and θ_{K}, the frame rotation angle 2311. L(C) is the rotation matrix, a rotational matrix, and could be represented in a few forms, matrix form (3 × 3 rot matrix) or as a rotation vector. A rotational vector is a vector whose direction (or unit vector) forms the axis of rotation and the magnitude represents the amount of rotation. The rotational vector L(C) is represented as K 2312, the unit vector representing the axis of rotation, and θ_{K} 2311, the magnitude of that rotation.

Once the golf ball 1304 is hit, the ball magnetometer 305 time series data 2314 is run through a low pass IIR filter 2307 to produce the filtered time series vector MBf 2313. The time series data 2314 is taken 2308 from the ball MR sensors 305 as an X_{R} 2315, Y_{R} 2316, and Z_{R} 2317 array. An IIR Filter is an infinite impulse response filter.

The ball magnetometer 305 time series data 2314, frame rotation axis vector 2312, and θ_{K} 2311, and the frame rotation angle 2311 are processed by the Rodrigues’ Rotation Formula 2306. The Rodrigues’ Rotation Formula 2306 is an efficient algorithm for rotating a vector in space, given an axis and angle of rotation (see FIG. 23A at 2306 for the formula). The filtered time series vector MBf 2313 is represented by v in the Rodrigues Rotation Formula. K 2312 and θ_{K} 2311 come from the Kabsch Algorithm. This creates a vector vᵣₒₜ aligned to the frame of reference.

Turning to FIG. 23B, the vector vᵣₒₜ aligned to the frame of reference is processed through spin direction and rate detection 2320 and post-processing 2340 to create the final results 2360.

The spin detection determines the prior vector difference 2321 by subtracting Vₙ₋₁ from Vₙ to get Vₚᵣᵢₒᵣ 2331. The second prior vector difference 2322 is also calculated by subtracting Vₙ₋₂ from Vₙ₋₁ to get V_{2nd_prior} 2332.

The rotation axes calculation 2323 is determined by multiplying Vₚᵣᵢₒᵣ by V_{2nd_prior} to get the vector S 2334. In post-processing 2340, S 2334 passes through a low-pass IIR filter 2341 to get the filtered spin axes vector S_{f} 2351. The final results 2360 provide the spin axes 2361.

The spin rate is calculated by finding the change Δθ_{S} 2335 in the Theta Calculation 2324 (see FIG. 23B at 2324 for the formula). The Theta vector Δθₛ 2335 is calculated by taking an arccosine of a dividend of a product of the prior vector Vₚᵣᵢₒᵣ 2331 difference multiplied by the second prior vector difference V_{2nd_prior} 2332 divided by a product of an absolute value of the prior vector difference Vₚᵣᵢₒᵣ 2331 multiplied by an absolute value of the second prior vector difference V_{2nd_prior} 2332. The change in Theta Δθ_{S} 2335 is then run through a low pass IIR filter 2325 to calculate the filtered change in Theta Δθ_{Sf} 2352.

The filtered change in Theta Δθ_{Sf} 2352 is converted using an angular velocity calculation 2342 by dividing Δθ_{Sf} 2352 by the change in time Δt to produce the angular velocity ώ 2352. Angular velocity ώ 2352 is converted to the spin rate 2362 as either a revolutions per minute value or a degrees per second value.

The spin rate and spin direction are then displayed on a screen, perhaps on the smartphone 401 In some embodiments, the display could look like the app in FIG. 8.

While the above invention specifies a golf ball, the same circuitry and software could be used to analyze a baseball, a hockey puck, a polo ball, a basketball, a football, a Frisbee, a softball, a soccer ball, a volleyball, a tennis ball, a handball, a rugby ball, a table tennis ball, a badminton birdie, a bowling ball, a field hockey ball, a cricket ball, a lacrosse ball, a curling rock, or a bocce ball. In many of these sports, the precise location of the ball is important to scoring, and the location of the BLE chip could be used with beacons to determine precisely whether, for instance, a hockey puck (or soccer ball, etc) has crossed into the net. It could also be used in volleyball or tennis to determine if the ball is in or out of bounds. The algorithms described herein could also be used for determining the characteristics of a bullet or other artillery as well as where it hit the target (allowing automatic scoring). The printed circuit board and its software could be used to analyze the spinning of bearings for bicycle tires, automotive wheels (and other rotating components), and in other devices with rotating components.

The foregoing devices and operations, including their implementation, will be familiar to, and understood by, those having ordinary skill in the art. All sizes used in this description could be scaled up or down without impacting the scope of these inventions. All angles have a tolerance of ± 10 degrees.

The above description of the embodiments, alternative embodiments, and specific examples, are given by way of illustration and should not be viewed as limiting. Further, many changes and modifications within the scope of the present embodiments may be made without departing from the spirit thereof, and the present invention includes such changes and modifications.

1. A method for determining a spin rate and a spin axes of a golf ball comprising:
collecting a user magnetometer frame of reference vector from a user magnetometer;
collecting a user accelerometer frame of reference vector from a user accelerometer;
collecting a ball magnetometer frame of reference vector from a ball magnetometer on the golf ball at rest;
collecting a ball accelerometer frame of reference vector from a ball accelerometer on the golf ball at rest;
calculating frame of rotation coefficients from the user magnetometer frame of reference vector, the user accelerometer frame of reference vector, the ball magnetometer frame of reference vector, and the ball accelerometer frame of reference vector using a Kabsch Algorithm;
collecting a ball magnetometer time series matrix from the ball magnetometer as the ball is in flight;
processing the ball magnetometer time series through a Rodrigues Rotation Formula using the frame rotation coefficients to create a rotation vector;
calculating a prior vector difference and a second prior vector difference;
calculating the spin axes by multiplying the prior vector difference by the second prior vector difference;
calculating a Theta vector by taking an arccosine of a dividend of a product of the prior vector difference multiplied by the second prior vector difference divided by a product of an absolute value of the prior vector difference multiplied by an absolute value of the second prior vector difference;
calculating the spin rate by dividing a change in Theta by the change in time; and
displaying the spin rate and the spin axes on a display device.

2. The method of claim 1 further comprises processing the ball magnetometer time series matrix through an infinite impulse response filter.

3. The method of claim 1 further comprises processing the spin axes through an infinite impulse response filter.

4. The method of claim 1 further comprises processing the spin rate through an infinite impulse response filter.

5. The method of claim 1 wherein the display device is a central interrogator.

6. The method of claim 5 wherein the spin axes and the spin rate are wirelessly sent to the display device.

7. The method of claim 1 wherein the user magnetometer is located on a ground near a golf tee.

8. A computing apparatus with non-transitory machine-readable media programmed to:
collect a user magnetometer frame of reference vector from a user magnetometer;
collect a user accelerometer frame of reference vector from a user accelerometer;
collect a ball magnetometer frame of reference vector from a ball magnetometer on a golf ball at rest;
collect a ball accelerometer frame of reference vector from a ball accelerometer on the golf ball at rest;
calculate frame of rotation coefficients from the user magnetometer frame of reference vector, the user accelerometer frame of reference vector, the ball magnetometer frame of reference vector, and the ball accelerometer frame of reference vector using a Kabsch Algorithm;
collect a ball magnetometer time series matrix from the ball magnetometer as the ball is in flight;
process the ball magnetometer time series through a Rodrigues Rotation Formula using the frame rotation coefficients to create a rotation vector;
calculate a prior vector difference and a second prior vector difference;
calculate a spin axes by multiplying the prior vector difference by the second prior vector difference;
calculate a Theta vector by taking an arccosine of a dividend of a product of the prior vector difference multiplied by the second prior vector difference divided by a product of an absolute value of the prior vector difference multiplied by an absolute value of the second prior vector difference;
calculate a spin rate by dividing a change in Theta by the change in time; and
display the spin rate and the spin axes on a display device connected to the computing apparatus.

9. The computing apparatus of claim 8 further programmed to process the ball magnetometer time series matrix through an infinite impulse response filter.

10. The computing apparatus of claim 8 further programmed to process the spin axes through an infinite impulse response filter.

11. The computing apparatus of claim 8 further programmed to process the spin rate through an infinite impulse response filter.

12. The computing apparatus of claim 8 wherein the display device is a smartphone.

13. The computing apparatus of claim 8 wherein the spin axes and the spin rate are wirelessly sent to the display device.

14. The computing apparatus of claim 8 wherein the user magnetometer is located on artificial grass, the artificial grass including a launch location for the golf ball.

15. A system comprising:
artificial grass including a launch location for a golf ball, a user magnetometer, and a user accelerometer;
the golf ball including a wireless interface, a ball magnetometer, and a ball accelerometer;
a central processing unit connected to the user magnetometer and the user accelerometer, the central processing unit further comprising a wireless transceiver wirelessly connected to the wireless interface, wherein the central processing unit creates frame rotation coefficients from data collected from the ball magnetometer, the ball accelerometer, the user magnetometer, and the user accelerometer using a Kabsch Algorithm;
where the central processing unit uses a Rodrigues Rotation Formula on the frame rotation coefficients and ball magnetometer data after the golf ball is hit by a golf club, to produce a prior vector difference vector and a second prior vector difference vector;
where the central processing unit uses the prior vector difference vector and the second prior vector difference vector to determine a spin axes and a spin rate; and
a display device connected to the central processing unit, the display device receives the spin axes and the spin rate from the central processing unit, and displays the spin axes and the spin rate.

16. The system of claim 15 where the launch location is a golf tee.

17. The system of claim 15 wherein the central processing unit resides in a smartphone.

18. The system of claim 15 wherein the spin axes and the spin rate are wirelessly sent to a smartphone.

19. The system of claim 15 wherein the ball magnetometer data comprises a matrix of X, Y, and Z coordinate data over time.

20. A system comprising:
artificial grass including a launch location for a golf ball, a user magnetometer, and a user accelerometer;
the golf ball including a wireless interface, a ball magnetometer, and a ball accelerometer;
a central processing unit connected to the user magnetometer and the user accelerometer, the central processing unit further comprising a wireless transceiver wirelessly connected to the wireless interface, wherein the central processing unit includes a means for creating frame rotation coefficients from data collected from the ball magnetometer, the ball accelerometer, the user magnetometer, and the user accelerometer;
where the central processing unit includes a means for producing a prior vector difference vector and a second prior vector difference vector from the frame rotation coefficients and ball magnetometer data after the golf ball is hit by a golf club;
where the central processing unit includes a means for determining a spin axes and a spin rate from the prior vector difference vector and the second prior vector difference vector; and
a display device connected to the central processing unit, the display device receives the spin axes and the spin rate from the central processing unit, and displays the spin axes and the spin rate.
